(19) United States
(12) Patent Application Publication
(10) Pub. No.: US 2026/0329648 A1
(43) Pub. Date: Oct. 22, 2026

(54) SYSTEM

(71) Applicant: SoftBank Group Corp., Tokyo (JP)

(72) Inventor: Motoki UMEDA, Tokyo (JP)

(73) Assignee: SoftBank Group Corp., Tokyo (JP)

(21) Appl. No.: 19/646,620

(22) Filed: Apr. 14, 2026

(30) Foreign Application Priority Data
Apr. 22, 2025 (JP) 2025-070623

(51) Int. Cl. G06F 9/50; G06N 3/042; G06N 3/0475

(52) U.S. Cl. CPC G06F 9/5027; G06N 3/042; G06N 3/0475

(57) ABSTRACT

The present invention relates to a system that automatically collects market trend data such as a sales volume of mobile terminals and the number of optional service acquisitions by diverse methods, performs trend analysis, visualization, factor analysis, and demand forecasting using generative AI, automatically generates specific plan proposals such as inventory securing, sales staff allocation, a sales promotion campaign, and a cross-selling measure based on an analysis result thereof, and presents the specific plan proposals to a user terminal. Thereby, the burden of analysis and plan formulation work on field personnel and managers can be significantly reduced, and rapid and highly accurate decision-making and strategic business promotion can be realized.

### CROSS-REFERENCE TO RELATED APPLICATION

The present application claims priority to and incorporates by reference the entire contents of Japanese Patent Application No. 2025-070623 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

Conventionally, there has been a problem that grasping market trends regarding sales of mobile terminals and acquisition of optional services, accurately analyzing current strengths and weaknesses based on these data, and further formulating specific plans such as inventory securing, sales staff allocation, implementation of a sales promotion campaign, and strengthening of a cross-selling measure after forecasting future demand require enormous data collection, organization, and analysis work, complex statistical processing, and further advanced specialized knowledge and experience, which requires a great deal of labor and time for field personnel and managers, resulting in difficulty in rapid and accurate decision-making and strategy formulation. However, the present invention has a main object of solving the problem in that by utilizing generative AI, a series of these operations are automated and streamlined, data visualization, trend analysis, demand forecasting, and plan formulation are realized end-to-end, the burden on field personnel and managers is significantly reduced, and more highly accurate decision-making and strategic business promotion are enabled.

### SUMMARY OF THE INVENTION

The present invention solves the problem by providing a system comprising a market trend data acquisition unit, a trend analysis unit using generative AI, and a plan formulation unit. That is, by adopting a configuration in which the market trend data acquisition unit automatically acquires time-series data such as a sales volume of mobile terminals and the number of optional service acquisitions from an external database, an internal management system, or the like, the trend analysis unit using generative AI analyzes an increase/decrease trend and a transition in the sales volume of mobile terminals and the number of optional service acquisitions based on the acquired time-series data, extracts strengths and weaknesses in natural language, and generates visualization information such as a graph, and further the plan formulation unit performs demand forecasting for the next month and thereafter using generative AI based on an analysis result and the visualization information of the trend analysis unit, automatically generates specific plan proposals such as inventory securing, sales staff allocation, a sales promotion campaign, and a cross-selling measure according to a demand forecasting result and a trend analysis result, and presents the specific plan proposals to a user terminal, this is a means to automate and streamline a series of business processes from data collection to analysis, demand forecasting, and plan formulation, significantly reduce the burden on field personnel and managers, and realize rapid and accurate decision-making and strategic business promotion.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

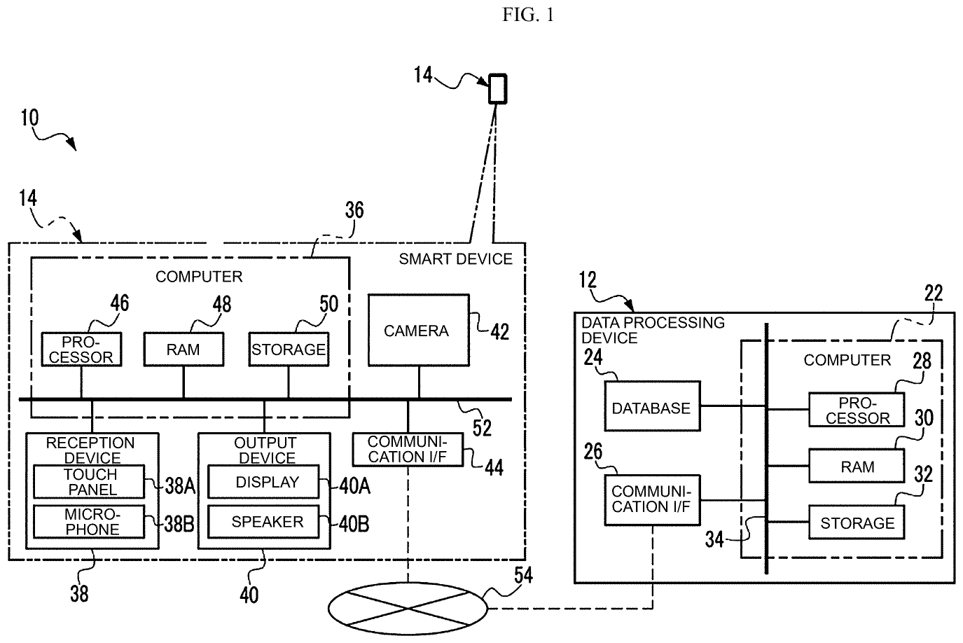

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

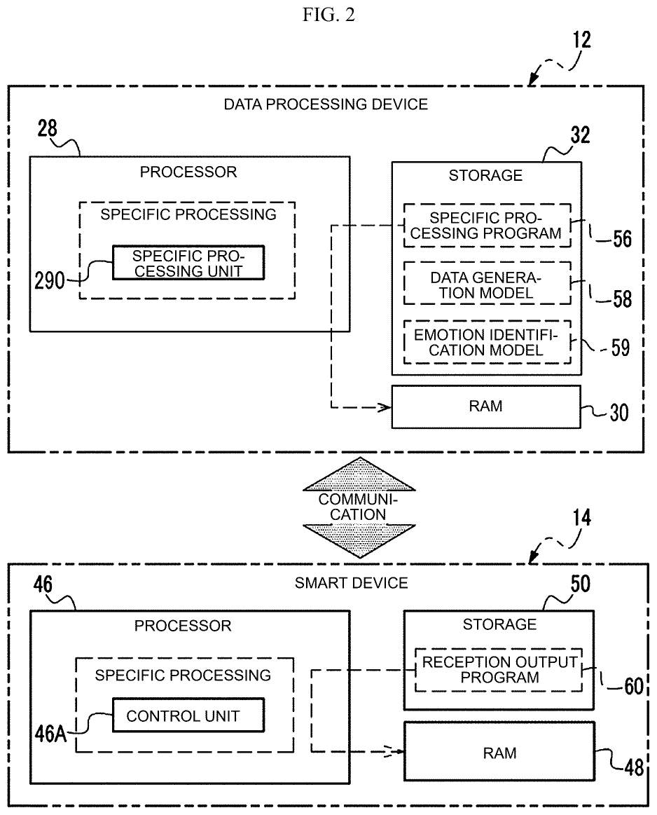

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention will be described more specifically and in detail. The system of the present invention is composed of a server and a terminal, and is configured to include a market trend data acquisition unit, a trend analysis unit using generative AI, and a plan formulation unit on the server side, and a user interface unit on the terminal side. The server may be configured in a cloud environment, an on-premises environment, or a hybrid environment thereof, and the terminal is configured by various devices such as a personal computer, a tablet terminal, a smartphone, and a dedicated business terminal. Specifically, the present system adopts a distributed computing architecture having a plurality of computing nodes. The present server is equipped with a plurality of dedicated computing processors for executing large-scale parallel computing. The present server includes a high-speed volatile memory and a large-capacity non-volatile storage. The present server interconnects each hardware component via a broadband internal bus. The present market trend data acquisition unit establishes communication with an external data source via a network interface. The present market trend data acquisition unit converts received raw data into a predetermined tensor format and expands it on a memory. The present trend analysis unit includes a deep learning model provided with a self-attention mechanism. The present trend analysis unit maps input time-series data to a high-dimensional vector space. The present plan formulation unit calculates an optimal action policy using a reinforcement learning algorithm. The present terminal incorporates a graphical processing unit. The present terminal renders structured data received from the server and outputs it to a display device. The present system significantly reduces latency of data processing by cooperative operation of these hardware and software. The present system completely eliminates conventional manual data aggregation work. The present system distributes a processing load at a peak time by a dynamic allocation function of computing resources. The present system thereby improves availability and throughput of the entire system. A specific application field of the present system includes a real-time inventory optimization system in a nationwide retail chain. The present system processes sales data of each store in milliseconds. The present system immediately recalculates a supply plan in response to a rapid fluctuation in demand. The present system thereby exhibits a technical effect of simultaneously minimizing a shortage risk and excess inventory. The present system further applies a data compression algorithm to suppress consumption of a communication band. The present system can also adopt a configuration of executing primary data filtering on the terminal side in cooperation with edge computing technology. The present system thereby reduces a data transfer amount to the server. The present system reduces a communication load of the entire network. The present system adopts a microservice architecture and deploys each function as an independent container. The present system thereby makes it possible to independently scale out only a specific functional module. The present system dramatically enhances fault tolerance of the entire system.

First, the market trend data acquisition unit will be described. This unit operates on the server and automatically acquires time-series data regarding a sales volume of mobile terminals and the number of optional service acquisitions by diverse methods. For example, it corresponds to diverse data sources, such as a case of acquiring sales performance data in real time from an internal sales management system using an API, a case of periodically extracting a sales history and an option acquisition history for the past several years from a database by batch processing, a case of importing monthly, weekly, and daily sales data from a CSV file or an Excel file uploaded by a sales representative, and a case of acquiring sales trend data of the entire market provided by an external market research company and public information of competitors by Web scraping or API linkage. Also, for example, it collects data from a plurality of related internal and external systems such as a POS system, an inventory management system, a customer management system, and a call center system, and automatically executes data normalization and cleansing processing. Furthermore, for example, it can acquire and accumulate data at various granularities, such as by sales channel (store, online, agency, etc.), by region (prefecture, municipality, store unit, etc.), by product category (smartphone, feature phone, tablet, etc.), and by period (daily, weekly, monthly, quarterly, annual, etc.). In addition, for example, it also includes a function of automatically detecting an abnormal value and a missing value at the time of data acquisition and performing complementation and exclusion processing. Specifically, the present market trend data acquisition unit establishes connections with a plurality of external systems simultaneously using an asynchronous communication protocol. The present market trend data acquisition unit maps the acquired heterogeneous data to a common data schema. The present market trend data acquisition unit executes encoding processing of converting character string data into a numerical vector. The present market trend data acquisition unit applies a K-nearest neighbor algorithm to a missing value to infer and complement a statistically valid numerical value. The present market trend data acquisition unit executes an isolation forest algorithm for outlier detection. The present market trend data acquisition unit assigns a specific flag to the detected abnormal value and excludes it from subsequent processing. The present market trend data acquisition unit converts the time-series data into a third-order tensor consisting of a batch size, a time step, and a feature dimension. Input data to the present market trend data acquisition unit is two-dimensional array data extracted from a comma-separated text file or a spreadsheet software file. A specific example of the input data to the present market trend data acquisition unit includes a record group including a date, a store ID, and a sales volume. Output data from the present market trend data acquisition unit is a multidimensional tensor including normalized floating-point numbers. A specific example of the output data from the present market trend data acquisition unit includes a time-series array of sales performance scaled to a range from zero to one. The tensor output by the present market trend data acquisition unit is directly transferred to a memory space of the subsequent trend analysis unit. The present market trend data acquisition unit heavily uses in-memory processing on a memory. The present market trend data acquisition unit thereby minimizes input/output access to a disk. The present market trend data acquisition unit brings about a technical effect of shortening an execution time of data preprocessing to one-hundredth or less compared to conventional batch processing. A specific application field of the present market trend data acquisition unit includes a real-time monitoring system for high-frequency trading data in a financial institution. The present market trend data acquisition unit processes a huge amount of transaction data generated in milliseconds without delay. The present market trend data acquisition unit can also adopt a configuration of executing parallel processing while guaranteeing data orderliness using a distributed message queue. The present market trend data acquisition unit thereby increases throughput of data processing to the utmost limit.

Next, the trend analysis unit using generative AI will be described. This unit also operates on the server, and performs multifaceted trend analysis using generative AI with the acquired time-series data as an input. For example, the generative AI analyzes monthly, weekly, and daily transitions of the sales volume of mobile terminals and the number of optional service acquisitions, and implements an increase/decrease trend, a seasonal variation, periodicity, a sudden fluctuation, detection of an abnormal value, a correlation analysis between the sales volume and the number of optional service acquisitions, a trend comparison by sales channel, by region, and by product category, and the like. For example, the generative AI automatically generates analysis results in natural language, such as “the sales volume has been steadily increasing over the past 12 months,” “an option acquisition rate is lower than the overall average,” “the sales volume rapidly increased in a specific month, which is inferred to be an influence of a new model release or a large-scale campaign,” “the option acquisition rate is remarkably high in a specific region,” and “a trend that the sales volume in an online channel exceeds that in a store channel is strengthening.” Furthermore, the generative AI also automatically generates visualization information such as a graph and a table. For example, it automatically generates a transition of the sales volume as a bar graph or a line graph, a transition of the option acquisition rate as a line graph or a heat map, a correlation between the sales volume and the number of optional service acquisitions as a scatter plot, a graph highlighting an abnormal value, and a comparison by channel, by region, and by product category as a radar chart or a stacked graph, respectively, and outputs them in a form that a user can intuitively understand. In addition, for example, regarding a factor of a rapid increase in the sales volume or a background of a decrease in the option acquisition rate, the generative AI can also present a hypothesis while referring to past data and external information. For example, it can explain by combining a plurality of factors, such as “the main factor of the increase in the sales volume is that a large-scale sales promotion campaign was implemented in conjunction with a new model release” and “there is a high possibility that a factor of the decrease in the option acquisition rate is that a competitor started a new optional service.” Furthermore, for example, the generative AI automatically extracts “strengths” and “weaknesses” in natural language, and outputs them in a form that a field person in charge or a manager can immediately understand, such as “it is a strength that the sales volume is stably increasing” and “it is a problem that the option acquisition rate is in a decreasing trend.” Specifically, the present trend analysis unit includes a large language model based on a transformer architecture as a core. The present trend analysis unit patches the time-series data and inputs it to a linear projection layer. The present trend analysis unit adds positional encoding to retain temporal order information of the data. The present trend analysis unit calculates a dependency relationship between different time steps using a multi-head attention mechanism. Input data to the present trend analysis unit is a two-dimensional numerical tensor including the sales volume and the number of optional service acquisitions for the past 365 days. A specific example of the input data to the present trend analysis unit includes an array in which integer values such as 150 and 200 are continuous. Output data from the present trend analysis unit is a token sequence of natural language indicating an analysis result and a generation probability distribution of each token. A specific example of the output data from the present trend analysis unit includes a text character string indicating that the sales volume is in an increasing trend and its reliability score. The text character string output by the present trend analysis unit is used as a part of a prompt in the subsequent plan formulation unit. The present trend analysis unit generates text through an autoregressive decoding process. The present trend analysis unit searches for a token sequence with the highest probability using a beam search algorithm. The present trend analysis unit adopts a multimodal learning method of mapping numerical data and text data to the same latent space. The present trend analysis unit thereby accurately extracts a business meaning behind a minute fluctuation of a numerical value. The present trend analysis unit completely replaces a conventional mental process in which a human visually checks a graph to grasp a trend. The present trend analysis unit exhibits a technical effect of discovering a complex correlation exceeding human cognitive limits by matrix calculation in a high-dimensional space. A specific application field of the present trend analysis unit includes a predictive maintenance system for production equipment in the manufacturing industry. The present trend analysis unit analyzes a minute change in vibration data and temperature data obtained from a sensor. The present trend analysis unit automatically generates a sign of failure as a natural language report. The present trend analysis unit can also adopt a configuration of arranging a module for extracting a local feature of time-series data using a convolutional neural network in a preceding stage. The present trend analysis unit thereby improves robustness against noise.

Furthermore, the plan formulation unit will be described. This unit also operates on the server, and automatically generates demand forecasting for the next month and thereafter and specific plan proposals using generative AI based on an analysis result and visualization information of the trend analysis unit. For example, the generative AI automatically constructs a linear regression or a time-series forecasting model (ARIMA, LSTM, etc.) based on time-series data, and predicts a sales volume and the number of optional service acquisitions for the next month, the next quarter, and the next fiscal year with high accuracy. For example, it outputs a forecasting result such as “the sales volume for the next month is expected to increase by 10% compared to the previous month” and “the number of optional service acquisitions is predicted to continue a trend of maintaining the status quo.” Furthermore, based on the forecasting result, the generative AI automatically generates a plurality of specific measures, such as “it is recommended to increase inventory by 20% because the sales volume is expected to increase next month,” “it is effective to implement cross-selling training for sales staff because an option acquisition rate is in a decreasing trend,” “it is desirable to plan a region-limited sales promotion campaign because the sales volume is sluggish in a specific region,” “it is effective to increase a web advertising budget to strengthen sales in an online channel,” and “an improvement in the option acquisition rate can be expected by implementing a free trial campaign for an optional service in conjunction with a new model release timing,” and also presents a priority, an implementation timing, an expected effect, a necessary resource, a cost estimate, a risk factor, and the like together. For example, the generative AI can also generate diverse plan proposals for improving efficiency of the entire business, such as “it is recommended to automatically set a target value and introduce a mechanism for monitoring an achievement degree for each store in real time,” “it is important to automatically create an inventory procurement schedule and minimize a shortage risk in cooperation with a logistics department,” and “it is effective to automatically formulate a sales staff allocation plan and optimize personnel during a busy season or a new model release.” Furthermore, for example, the generative AI can learn a past measure implementation history and its effect data, and propose a more effective measure. For example, it is also possible to utilize empirical knowledge, such as “among campaigns implemented in the past, a specific promotion contributed most to the improvement of the option acquisition rate, so it is recommended to implement the same measure again.” Specifically, the present plan formulation unit includes a hybrid architecture integrating a long short-term memory network and a large language model. The present plan formulation unit inputs past time-series data to the long short-term memory network to perform regression prediction of a future numerical value. The present plan formulation unit combines a predicted numerical vector and text data from the trend analysis unit and inputs them to the large language model. Input data to the present plan formulation unit is a one-dimensional array indicating past sales performance and a vector of categorical variables indicating a measure history. A specific example of the input data to the present plan formulation unit includes an array of monthly sales volumes for the past 12 months and an array of campaign implementation flags. Output data from the present plan formulation unit is a list of recommended measures and a floating-point score indicating an expected profit of each measure. A specific example of the output data from the present plan formulation unit includes text data instructing an inventory increase and numerical data indicating its expected profit. The measure list output by the present plan formulation unit is sorted in order of priority and displayed in the subsequent user interface unit. The present plan formulation unit searches for an optimal measure sequence using a framework of a Markov decision process in reinforcement learning. The present plan formulation unit updates a weight of a neural network using a policy gradient method so as to maximize an expected reward. The present plan formulation unit executes a Monte Carlo simulation to quantitatively evaluate a risk distribution of each measure. The present plan formulation unit thereby derives a dynamic and global optimal solution that is impossible with a simple rule-based conditional branch. The present plan formulation unit brings about a technical effect of converting a plan formulation process that relied on human experience and intuition into a data-driven mathematical optimization problem. A specific application field of the present plan formulation unit includes a dynamic optimization system for a delivery route and personnel allocation in the logistics industry. The present plan formulation unit generates an optimal delivery plan in real time based on weather data and traffic condition prediction. The present plan formulation unit can also adopt a configuration of generating a large number of virtual market scenarios using a generative adversarial network and pre-learning an optimal measure for them. The present plan formulation unit thereby dramatically improves an adaptive capability of the system to an unknown market fluctuation.

The user interface unit operates on the terminal and presents a trend analysis result, visualization information, a plan proposal, and the like transmitted from the server to a user. For example, a sales volume transition graph, an option acquisition rate graph, an analysis comment in natural language by generative AI, a list of plan proposals, a priority and an implementation schedule of a measure, a simulation result of an expected effect, and the like are collectively displayed on a dashboard screen on the terminal so that the user can easily grasp a current situation and make a decision. Furthermore, for example, the user can specify conditions such as an analysis target period, a target region, a target product, a sales channel, and a type of measure from the terminal and transmit a request to the server, and the server side can execute trend analysis and plan formulation again and return the result to the terminal in real time. In addition, for example, the user can select a measure desired to be implemented from the plan proposals and transmit feedback to the server, thereby reflecting it in subsequent analysis and plan formulation. Furthermore, for example, the user can input performance data after implementing the measure from the terminal, and the server side can realize effect verification of the measure and automation of a PDCA cycle. Specifically, the present user interface unit is implemented as a single-page application operating on a web browser. The present user interface unit redraws only a difference of a screen at high speed using a virtual document object model. The present user interface unit establishes a persistent connection using a WebSocket protocol with the server. The present user interface unit receives structured data transmitted asynchronously from the server in real time. Input data to the present user interface unit is an event object generated by a user's touch operation or mouse click. A specific example of the input data to the present user interface unit includes coordinate data and a time stamp indicating that a specific button on the screen has been pressed. Output data from the present user interface unit is a request payload in a JSON format transmitted to the server. A specific example of the output data from the present user interface unit includes character string data including a start date and an end date of the analysis target period. The request payload output by the present user interface unit is routed to each processing module via an API gateway on the server side. The present user interface unit utilizes a graphical processing unit incorporated in the terminal to execute rendering of a complex three-dimensional graph and a heat map by hardware acceleration. The present user interface unit thereby reduces a load on a main processor and improves a frame rate of drawing. The present user interface unit includes a function of recording a user's line-of-sight movement and operation history in a local storage and self-optimizing operability. The present user interface unit exhibits a technical effect of adopting an optimistic UI update method for concealing a network delay. A specific application field of the present user interface unit includes an integrated display system for an electronic medical record and diagnosis support information in a medical institution. The present user interface unit supports a doctor to intuitively grasp a patient's condition and make a rapid decision on a treatment policy. The present user interface unit can also adopt a configuration of providing a part of functions even in an offline environment using progressive web app technology. The present user interface unit thereby ensures business continuity in a place where a communication environment is unstable.

In this way, the system of the present invention is configured to consistently execute automatic acquisition of market trend data, multifaceted trend analysis and visualization by generative AI, and demand forecasting and plan formulation by generative AI on the server side, and realize information presentation and interaction to a user on the terminal side, and utilizes generative AI as an essential element in a wide range of business areas, such as sales management business of mobile terminals, formulation of an acquisition strategy for an optional service, an inventory procurement plan, a sales staff allocation plan, planning of a sales promotion campaign, strengthening of a cross-selling measure, automatic setting of a target value, formulation of a regional strategy, risk management by abnormal value detection, automatic verification of a measure effect, automation of a PDCA cycle, knowledge utilization of past measures, information sharing among a plurality of departments, and automatic generation of a report for management, thereby realizing reduction of a business burden on a field person in charge and a manager, business efficiency improvement, and further sophistication of strategic decision-making. Furthermore, for example, in the future, a system design capable of flexibly responding to various expansions such as voice input, an interactive interface by natural language, expansion of external data linkage, API linkage with other companies' systems, optimization for mobile terminals, security enhancement, and multi-tenant support can be adopted. Specifically, the present system deploys each processing module as a loosely coupled microservice on a container orchestration platform. The present system collects a load status of the entire system in milliseconds by a monitoring agent. The present system executes an autoscaling algorithm based on the collected metrics and dynamically allocates necessary computing resources. Input data to the present system is a time-series performance indicator vector indicating an operating status of the entire system. A specific example of the input data to the present system includes a percentage value indicating a CPU usage rate and a memory consumption amount. Output data from the present system is a control command instructing start or stop of a container. A specific example of the output data from the present system includes an API request to increase the number of specific service instances. The control command output by the present system is immediately executed in an infrastructure management layer. The present system applies end-to-end encryption across the entire data pipeline to guarantee data confidentiality at a hardware level. The present system visualizes a processing path of each request using distributed tracing technology and automatically identifies a bottleneck. The present system thereby brings about a technical effect of dramatically reducing an operation and maintenance cost in a large-scale data processing environment. A specific application field of the present system includes an integrated management platform for urban infrastructure in a smart city. The present system integrates a huge amount of sensor information such as traffic volume data and power consumption data in real time to optimize urban functions. The present system can also adopt a configuration of executing federated learning on an edge device side and sharing only a weight of a model without transmitting raw data to the server. The present system thereby achieves both privacy protection and continuous improvement of a machine learning model.

### System Configuration

The system according to the present embodiment includes a market trend data acquisition unit, a generative AI trend analysis unit, a plan formulation unit, a user interface unit, a database management unit, an external linkage unit, and a security management unit. The market trend data acquisition unit has a function of automatically acquiring time-series data regarding a sales volume of mobile terminals and the number of optional service acquisitions by diverse methods, and corresponds to diverse data sources, such as a case of acquiring sales performance data in real time from an internal sales management system using an API, a case of periodically extracting a sales history and an option acquisition history for the past several years from a database by batch processing, a case of importing monthly, weekly, and daily sales data from a CSV file or an Excel file uploaded by a sales representative, and a case of acquiring sales trend data of the entire market provided by an external market research company and public information of competitors by Web scraping or API linkage. Also, it collects data from a plurality of related internal and external systems such as a POS system, an inventory management system, a customer management system, and a call center system, and automatically executes data normalization and cleansing processing. Furthermore, it can acquire and accumulate data at various granularities, such as by sales channel, by region, by product category, and by period, and also includes a function of automatically detecting an abnormal value and a missing value at the time of data acquisition and performing complementation and exclusion processing. Specifically, the present system interconnects each functional unit via a high-speed system bus and a virtual network interface. The present market trend data acquisition unit receives asynchronous data streams from a plurality of data sources in parallel using multi-thread processing. The present market trend data acquisition unit analyzes header information of a received data packet to determine a type and a priority of data. The present market trend data acquisition unit stores the data in a ring buffer on a memory based on the priority. Input data to the present market trend data acquisition unit is a byte sequence of raw data transmitted from an external system. A specific example of the input data to the present market trend data acquisition unit includes character string data in a JSON format included in an HTTP response body. Output data from the present market trend data acquisition unit is structure data in a binary format optimized for internal processing. A specific example of the output data from the present market trend data acquisition unit includes a memory block in which a floating-point number and a time stamp are packed. The structure data output by the present market trend data acquisition unit is persisted by the database management unit and pushed to an input queue of the generative AI trend analysis unit. The present market trend data acquisition unit unifies a scale of data using a Z-score normalization algorithm. The present market trend data acquisition unit applies a moving average filter to remove high-frequency noise. The present market trend data acquisition unit thereby exhibits a technical effect of improving a convergence speed of a machine learning model in a subsequent stage. A specific application field of the present market trend data acquisition unit includes a real-time analysis system for a flight data recorder in the aviation industry. The present market trend data acquisition unit collects a huge amount of time-series data sent from various sensors of an aircraft without omission. The present market trend data acquisition unit can also adopt a configuration of mounting a hardware accelerator dedicated to data compression to minimize consumption of a network band. The present market trend data acquisition unit thereby realizes stable data collection even in a limited communication environment.

The generative AI trend analysis unit has a function of performing multifaceted trend analysis using generative AI with the acquired time-series data as an input. For example, it analyzes monthly, weekly, and daily transitions of a sales volume of mobile terminals and the number of optional service acquisitions, and implements an increase/decrease trend, a seasonal variation, periodicity, a sudden fluctuation, detection of an abnormal value, a correlation analysis between the sales volume and the number of optional service acquisitions, a trend comparison by sales channel, by region, and by product category, and the like. For example, it automatically generates analysis results in natural language, such as the sales volume has been steadily increasing over the past 12 months, an option acquisition rate is lower than the overall average, the sales volume rapidly increased in a specific month, which is inferred to be an influence of a new model release or a large-scale campaign, the option acquisition rate is remarkably high in a specific region, and a trend that the sales volume in an online channel exceeds that in a store channel is strengthening. Furthermore, it also automatically generates visualization information such as a graph and a table, automatically generates a transition of the sales volume as a bar graph or a line graph, a transition of the option acquisition rate as a line graph or a heat map, a correlation between the sales volume and the number of optional service acquisitions as a scatter plot, a graph highlighting an abnormal value, and a comparison by channel, by region, and by product category as a radar chart or a stacked graph, respectively, and outputs them in a form that a user can intuitively understand. In addition, regarding a factor of a rapid increase in the sales volume or a background of a decrease in the option acquisition rate, the generative AI can also present a hypothesis while referring to past data and external information, and can explain by combining a plurality of factors, such as the main factor of the increase in the sales volume is that a large-scale sales promotion campaign was implemented in conjunction with a new model release, and there is a high possibility that a factor of the decrease in the option acquisition rate is that a competitor started a new optional service. Furthermore, the generative AI automatically extracts strengths and weaknesses in natural language, and outputs them in a form that a field person in charge or a manager can immediately understand, such as it is a strength that the sales volume is stably increasing, and it is a problem that the option acquisition rate is in a decreasing trend. Specifically, the present generative AI trend analysis unit executes a deep neural network composed of an encoder and a decoder on a dedicated tensor processing unit. The present generative AI trend analysis unit inputs time-series data to a one-dimensional convolutional layer to extract a local feature map. The present generative AI trend analysis unit inputs the extracted feature map to a transformer encoder to learn a global dependency relationship. Input data to the present generative AI trend analysis unit is a multidimensional tensor of normalized time-series numerical values. A specific example of the input data to the present generative AI trend analysis unit includes an array of floating-point numbers indicating past sales performance. Output data from the present generative AI trend analysis unit is an embedding vector of text indicating an analysis result and a coordinate data array for graph drawing. A specific example of the output data from the present generative AI trend analysis unit includes a sequence of word IDs of natural language and a set of XY coordinate values on a two-dimensional plane. The data output by the present generative AI trend analysis unit is transmitted in parallel to the subsequent plan formulation unit and user interface unit. The present generative AI trend analysis unit applies a softmax function in a decoder layer to calculate a probability distribution of a word appearing next. The present generative AI trend analysis unit generates diverse and natural sentences using a top-p sampling method. The present generative AI trend analysis unit pre-learns a weight of a model using a cross-entropy loss function. The present generative AI trend analysis unit thereby brings about a technical effect of reducing a time for a human to manually aggregate data and create a report to zero. A specific application field of the present generative AI trend analysis unit includes an automatic generation system for a market report of algorithmic trading in a financial market. The present generative AI trend analysis unit reads market sentiment from a minute fluctuation pattern of a stock price and immediately texturizes it. The present generative AI trend analysis unit can also adopt a configuration of adding a module for verifying factual accuracy of a generated hypothesis in cooperation with an external knowledge graph database. The present generative AI trend analysis unit thereby suppresses an erroneous output peculiar to AI called hallucination.

The plan formulation unit has a function of automatically generating demand forecasting for the next month and thereafter and specific plan proposals using generative AI based on an analysis result and visualization information of the trend analysis unit. For example, it automatically constructs a linear regression or a time-series forecasting model based on time-series data, and predicts a sales volume and the number of optional service acquisitions for the next month, the next quarter, and the next fiscal year with high accuracy. It outputs a forecasting result such as the sales volume for the next month is expected to increase by 10% compared to the previous month, and the number of optional service acquisitions is predicted to continue a trend of maintaining the status quo. Furthermore, based on the forecasting result, it automatically generates a plurality of specific measures, such as it is recommended to increase inventory by 20% because the sales volume is expected to increase next month, it is effective to implement cross-selling training for sales staff because an option acquisition rate is in a decreasing trend, it is desirable to plan a region-limited sales promotion campaign because the sales volume is sluggish in a specific region, it is effective to increase a web advertising budget to strengthen sales in an online channel, and an improvement in the option acquisition rate can be expected by implementing a free trial campaign for an optional service in conjunction with a new model release timing, and also presents a priority, an implementation timing, an expected effect, a necessary resource, a cost estimate, a risk factor, and the like together. Furthermore, it is also possible to generate diverse plan proposals for improving efficiency of the entire business, such as it is recommended to automatically set a target value and introduce a mechanism for monitoring an achievement degree for each store in real time, it is important to automatically create an inventory procurement schedule and minimize a shortage risk in cooperation with a logistics department, and it is effective to automatically formulate a sales staff allocation plan and optimize personnel during a busy season or a new model release. Furthermore, it can learn a past measure implementation history and its effect data, and propose a more effective measure, and it is also possible to utilize empirical knowledge, such as among campaigns implemented in the past, a specific promotion contributed most to the improvement of the option acquisition rate, so it is recommended to implement the same measure again. Specifically, the present plan formulation unit is equipped with a prediction engine that ensembles a gradient boosting decision tree and a deep learning model. The present plan formulation unit performs a weighted average of predicted values of each model so as to minimize an objective function in an input feature space. The present plan formulation unit solves a constrained nonlinear optimization problem using a solver based on predicted demand data. Input data to the present plan formulation unit is an embedding vector of text output from the trend analysis unit and a time stamp indicating a prediction target period. A specific example of the input data to the present plan formulation unit includes a 768-dimensional real number vector and an integer value indicating a future date. Output data from the present plan formulation unit is a structured JSON object including a parameter group of a recommended measure. A specific example of the output data from the present plan formulation unit includes a set of key-value pairs including a measure ID, an expected profit amount, and an execution probability. The structured data output by the present plan formulation unit is stored in the database management unit and transmitted to the user interface unit. The present plan formulation unit executes offline reinforcement learning using past measure data to optimize a policy network. The present plan formulation unit updates a value function and a policy function simultaneously using an actor-critic method. The present plan formulation unit thereby exhibits a technical effect of searching for a measure group with the highest expected value from a huge number of combinations in milliseconds. A specific application field of the present plan formulation unit includes a supply and demand adjustment system for a smart grid in a power grid. The present plan formulation unit automatically generates an optimal power generation plan and a charge/discharge schedule of a storage battery from weather forecast data and past power consumption data. The present plan formulation unit can also adopt a configuration of searching for an optimal solution evolutionarily while crossing and mutating a plurality of plan proposals using a genetic algorithm. The present plan formulation unit thereby avoids a risk of falling into a local optimal solution and formulates a more robust plan.

The user interface unit has a function of presenting a trend analysis result, visualization information, a plan proposal, and the like transmitted from the server to a user, and collectively displays a sales volume transition graph, an option acquisition rate graph, an analysis comment in natural language by generative AI, a list of plan proposals, a priority and an implementation schedule of a measure, a simulation result of an expected effect, and the like on a dashboard screen on the terminal, so that the user can easily grasp a current situation and make a decision. It is also possible that the user specifies conditions such as an analysis target period, a target region, a target product, a sales channel, and a type of measure from the terminal and transmits a request to the server, and the server side executes trend analysis and plan formulation again and returns the result to the terminal in real time. It is also possible to reflect it in the analysis and plan formulation from the next time onward by the user selecting a measure desired to be implemented from the plan proposals and transmitting feedback to the server. It is also possible that the user inputs performance data after implementing the measure from the terminal, and the server side realizes effect verification of the measure and automation of a PDCA cycle. Specifically, the user interface unit implements a state management container based on a reactive programming paradigm. The user interface unit monitors a data push notification from the server and asynchronously re-renders only a component whose state has changed. The user interface unit immediately reflects an input value of the user in an internal model using bidirectional data binding. Input data to the user interface unit is serialized data in a binary format transmitted from the server. A specific example of the input data to the user interface unit includes a vertex data array for graph drawing encoded in a protocol buffer format. Output data from the user interface unit is a log data vector including an operation history and feedback of the user. A specific example of the output data from the user interface unit includes numerical data indicating an ID of a clicked element and a staying time. The log data output by the user interface unit is fed back to a machine learning pipeline on the server side and used for re-learning of a model. The user interface unit executes advanced data filtering processing on a browser at a near-native speed using WebAssembly technology. The user interface unit thereby brings about a technical effect of reducing unnecessary communication to the server and dramatically improving responsiveness of an application. A specific application field of the user interface unit includes a real-time monitoring dashboard in a production line of a factory. The user interface unit visualizes data sent from thousands of sensors on a screen without delay and immediately displays an alert when an abnormality occurs. The user interface unit can also adopt a configuration of providing a three-dimensional spatial interface corresponding to a virtual reality or augmented reality device. The user interface unit thereby provides a more intuitive and immersive data analysis environment to the user.

A database management unit is responsible for accumulation, management, search, backup, restoration, access authority management, and the like of various data, and centrally manages, for example, sales performance data, option acquisition data, a measure implementation history, a user operation history, an external data linkage history, and the like. A database can be operated by combining a plurality of types such as a relational type, a NoSQL type, and a time-series database type according to an application. Maintenance of data consistency, high-speed search, data encryption, recording of an access log, and the like are also implemented. Specifically, the database management unit drives a multi-model database engine constructed on a distributed file system. The database management unit constructs a B-tree index for structured data to optimize an execution plan of a search query. The database management unit executes hash-based sharding for unstructured data to distributively arrange the data in a plurality of storage nodes. Input data to the database management unit is a character string of an SQL query or an API request issued from each functional module. A specific example of the input data to the database management unit includes a SELECT statement for extracting sales data of a specific period. Output data from the database management unit is a record set or a status code obtained as an execution result of the query. A specific example of the output data from the database management unit includes hundreds of data rows matching a condition and an integer value indicating processing success. The record set output by the database management unit is directly mapped to a memory space of a requesting module. The database management unit strictly guarantees atomicity and consistency in a distributed environment using a two-phase commit protocol in transaction processing. The database management unit applies Gorilla compression, which is a dedicated compression algorithm, to time-series data to significantly reduce a storage capacity. The database management unit thereby exhibits a technical effect of maintaining a search response time on the order of milliseconds even for petabyte-class large-scale data. A specific application field of the database management unit includes an integrated management system of call histories and packet communication logs of tens of millions of users in a telecommunications carrier. The database management unit simultaneously processes a complex analysis query while writing a huge amount of log data in real time. The database management unit can also adopt a configuration in which an in-memory database is arranged in a preceding stage as a cache layer to hold frequently accessed data on a memory. The database management unit thereby eliminates a bottleneck of disk IO and maximizes throughput of the entire system.

An external linkage unit is responsible for data linkage with an external system or an external service, and connects with diverse external systems by API, batch linkage, file linkage, or the like, such as an API of a market research company, acquisition of public information of a competitor, inventory linkage with a logistics system, linkage with an advertisement distribution system, and data linkage with an external BI tool. Data conversion and format conversion at the time of external linkage, authentication/authorization processing, error detection and retry processing, and the like are also implemented. Specifically, the external linkage unit functions as an API gateway in a microservices architecture. The external linkage unit exchanges a secure authorization token with the external system using an OAuth 2.0 protocol. The external linkage unit includes a message queue broker based on a publish-subscribe model. Input data to the external linkage unit is payload data in diverse formats transmitted from the external system. A specific example of the input data to the external linkage unit includes inventory information in an XML format and a comma-separated advertisement distribution log. Output data from the external linkage unit is a serialized object converted into a standard format inside the system. A specific example of the output data from the external linkage unit includes a data stream in a JSON format compliant with an internal schema. The data stream output by the external linkage unit is routed to a market trend data acquisition unit or a database management unit. The external linkage unit executes schema validation on the received data and blocks data in an invalid format at the border. When a communication error occurs, the external linkage unit automatically executes retransmission processing while suppressing a server load using an exponential backoff algorithm. The external linkage unit thereby brings about a technical effect of preventing a failure or delay of the external system from spreading to the internal system. A specific application field of the external linkage unit includes a data integration platform among a plurality of vendors in a global supply chain management system. The external linkage unit seamlessly connects a group of systems operating with different standards and protocols in each country. The external linkage unit can also adopt a configuration of implementing a circuit breaker pattern to temporarily block a connection to an external service with a slow response and execute failover processing. The external linkage unit thereby maximizes availability and fault tolerance of the entire system.

A security management unit is responsible for security of the entire system, and implements multilayered security measures such as user authentication/authorization, communication encryption, unauthorized access detection, data falsification detection, access authority management, recording of an audit log, malware countermeasures, vulnerability diagnosis, and data masking. Specifically, the security management unit dynamically verifies all communication requests based on a zero-trust network architecture. The security management unit strongly encrypts data transfer between nodes using a transport layer security protocol. The security management unit incorporates a deep learning model using an autoencoder to execute anomaly detection of network traffic. Input data to the security management unit is header information of a packet flowing in the system and a statistical feature vector of a payload. A specific example of the input data to the security management unit includes a numerical array indicating a source IP address, a packet size, and a communication frequency. Output data from the security management unit is an anomaly score indicating a threat level of each communication session and a blocking command. A specific example of the output data from the security management unit includes an integer value from zero to one hundred and a rule update instruction for a firewall. The blocking command output by the security management unit is immediately applied to a network switch to physically disconnect unauthorized communication. The security management unit protects data by applying an advanced encryption standard algorithm to confidential information stored in a database. The security management unit thoroughly enforces a principle of least privilege according to a job title and an affiliation of a user using a role-based access control mechanism. The security management unit thereby exhibits a technical effect of mathematically minimizing an information leakage risk due to an internal crime or a cyberattack from the outside. A specific application field of the security management unit includes a closed network system handling highly confidential information in a government agency or a financial institution. The security management unit autonomously constructs a defense posture even against a national-level cyberattack. The security management unit can also adopt a configuration of recording a hash value of an audit log in a distributed ledger using blockchain technology. The security management unit thereby makes falsification of log data completely impossible and ensures reliability of a forensic investigation.

Specific examples of a prompt sentence to be read by generative AI include, for example, “Based on time-series data of a sales volume of mobile terminals and the number of optional service acquisitions for the past 24 months, perform an increase/decrease trend, a seasonal variation, an abnormal value, a trend comparison by sales channel and by region, and a correlation analysis between the sales volume and the number of optional service acquisitions for the sales volume and the number of optional service acquisitions, extract strengths and weaknesses in natural language, and further generate visualization information such as a graph and a table”, “Based on a sales volume transition and an option acquisition rate transition for the latest 6 months, predict a sales volume and the number of optional service acquisitions for the next month, automatically generate a plurality of specific plan proposals such as inventory securing, sales staff allocation, a sales promotion campaign, and a cross-selling measure based on a prediction result, and present a priority and an expected effect together”, “Present a hypothesis in natural language while referring to past data and external information regarding a factor of a rapid increase in the sales volume and a background of a decrease in the option acquisition rate at the time of releasing a new model”, and “Extract the most effective measure based on effect data of a sales promotion campaign implemented in the past, and generate a proposal to be utilized for future measure formulation”. Specifically, the system divides these natural language prompts into an array of subword tokens using a byte-pair encoding algorithm. The system maps each divided token to a high-dimensional continuous vector space by multiplying it with a pre-trained embedding matrix. The system adds positional encoding based on a sine wave function to each vector to retain context information of the prompt. Input data to the system is a one-dimensional array of token IDs obtained by converting the prompt sentence. A specific example of the input data to the system includes a sequence of integer values corresponding to a vocabulary dictionary of tens of thousands of types. Output data from the system is an array of new token IDs generated as a response to the prompt and a probability distribution thereof. A specific example of the output data from the system includes a group of IDs of words constituting an analysis result and a plan proposal. The token array output by the system is inversely converted into a text character string of natural language again by a decoder module. The system dynamically optimizes a structure of an input text using prompt engineering technology. The system adds a role of a model and a constraint of an output format as metadata as a system prompt. The system thereby brings about a technical effect of improving inference accuracy of a large language model and preventing an output in an unintended format. A specific application field of the system includes a back-end system of an automatic response chatbot in customer support. The system internally generates an appropriate prompt for an ambiguous inquiry from a customer and derives an accurate answer. The system can also adopt a configuration of adopting a few-shot prompting method to include some input/output examples in the prompt. The system thereby dramatically improves task adaptation capability of the model without fine-tuning.

### Implementation Steps

Step 1: Automatic Collection of Market Trend Data A market trend data acquisition unit on a server automatically collects time-series data regarding a sales volume of mobile terminals and the number of optional service acquisitions by diverse methods. For example, it acquires sales performance data in real time from an internal sales management system using an API, periodically extracts a sales history and an option acquisition history for the past several years from a database by batch processing, imports monthly, weekly, and daily sales data from a CSV file or an Excel file uploaded by a sales representative, and acquires sales trend data of the entire market provided by an external market research company and public information of a competitor by Web scraping or API linkage. In addition, it also collects data from a plurality of related internal and external systems such as a POS system, an inventory management system, a customer management system, and a call center system, and automatically implements data normalization and cleansing processing. It acquires and accumulates data at various granularities such as by sales channel, by region, by product category, and by period, automatically detects an abnormal value and a missing value, and performs complementation and exclusion processing. Specifically, the market trend data acquisition unit executes a data pipeline for performing extraction, conversion, and writing at high speed on a memory. The market trend data acquisition unit parallelizes polling processing for a plurality of data sources using a multi-process architecture. The market trend data acquisition unit parses the acquired raw data and stores it in a data frame object on the memory. Input data to the market trend data acquisition unit is a byte stream received via a network socket. A specific example of the input data to the market trend data acquisition unit includes a payload portion of an encrypted communication packet. Output data from the market trend data acquisition unit is a clean multidimensional tensor for which missing value complementation and normalization have been completed. A specific example of the output data from the market trend data acquisition unit includes an array of floating-point numbers reshaped to match the number of dimensions of an input layer of a machine learning model. The tensor output by the market trend data acquisition unit is delivered to a subsequent trend analysis process with zero copy via a shared memory area. The market trend data acquisition unit removes unnecessary symbols and blanks from text data at high speed using a regular expression engine. The market trend data acquisition unit calculates a Mahalanobis distance for outlier detection and automatically filters a data point exceeding a statistical threshold. The market trend data acquisition unit thereby exhibits a technical effect of fundamentally eliminating a risk of overfitting in which a subsequent AI model learns noise. A specific application field of the market trend data acquisition unit includes a data fusion system from a plurality of sensors in an autonomous driving vehicle. The market trend data acquisition unit synchronizes and integrates a huge amount of data from a camera, a LiDAR, and a millimeter-wave radar in units of milliseconds. The market trend data acquisition unit can also adopt a configuration of integrating a distributed messaging system such as Apache Kafka as a data stream processing engine. The market trend data acquisition unit thereby constructs a scalable collection platform even for petabyte-class data traffic.

Step 2: Trend Analysis and Visualization by Generative AI A generative AI trend analysis unit on the server performs multifaceted trend analysis using generative AI with the collected time-series data as an input. For example, it analyzes monthly, weekly, and daily transitions of the sales volume of mobile terminals and the number of optional service acquisitions, and implements an increase/decrease trend, a seasonal variation, periodicity, a sudden fluctuation, detection of an abnormal value, a correlation analysis between the sales volume and the number of optional service acquisitions, a trend comparison by sales channel, by region, and by product category, and the like. Furthermore, it also automatically generates visualization information such as a graph and a table, automatically generates a transition of the sales volume with a bar graph or a line graph, a transition of an option acquisition rate with a line graph or a heat map, a correlation between the sales volume and the number of optional service acquisitions with a scatter plot, a graph highlighting an abnormal value, and a comparison by channel, by region, and by product category with a radar chart or a stacked graph, respectively, and outputs them in a form that the user can intuitively understand. A specific example of a prompt sentence to be read by generative AI includes “Based on time-series data of a sales volume of mobile terminals and the number of optional service acquisitions for the past 24 months, perform an increase/decrease trend, a seasonal variation, an abnormal value, a trend comparison by sales channel and by region, and a correlation analysis between the sales volume and the number of optional service acquisitions for the sales volume and the number of optional service acquisitions, extract strengths and weaknesses in natural language, and further generate visualization information such as a graph and a table”. Specifically, the generative AI trend analysis unit parallelly executes a large-scale matrix multiplication operation using a dedicated tensor operation processor. The generative AI trend analysis unit linearly converts the input time-series tensor into each matrix of a query, a key, and a value of a self-attention mechanism. The generative AI trend analysis unit calculates an inner product of the query and the key, applies a softmax function, and calculates an attention weight. Input data to the generative AI trend analysis unit is a preprocessed time-series data tensor and a token embedding vector of a prompt. A specific example of the input data to the generative AI trend analysis unit includes a third-order tensor having a batch size, a sequence length, and a hidden layer dimension. Output data from the generative AI trend analysis unit is a token probability distribution constituting a text of an analysis result and structured data for graph drawing. A specific example of the output data from the generative AI trend analysis unit includes a vector indicating an appearance probability of each vocabulary and a graph setting parameter in a JSON format. The data output by the generative AI trend analysis unit is passed to a subsequent factor analysis step and a drawing engine of a user interface. The generative AI trend analysis unit adopts a GELU function as an activation function in a process of forward propagation calculation to acquire a non-linear feature representation. The generative AI trend analysis unit applies layer normalization to suppress an internal covariate shift and enhance stability of learning and inference. The generative AI trend analysis unit thereby brings about a technical effect of completing data analysis and report creation work, which takes a human several days, in a few seconds. A specific application field of the generative AI trend analysis unit includes an automatic detection of a lesion site and a finding report generation system in medical image diagnosis. The generative AI trend analysis unit detects a minute abnormality from an image tensor of MRI or CT and outputs a finding for a doctor in natural language. The generative AI trend analysis unit can also adopt a configuration of dropping precision of a weight parameter from 32-bit floating point to 8-bit integer using model quantization technology. The generative AI trend analysis unit thereby significantly reduces memory usage and calculation time while maintaining inference accuracy.

Step 3: Factor Analysis and Hypothesis Generation by Generative AI The generative AI trend analysis unit generates a hypothesis in natural language regarding a fluctuation factor and a background of the sales volume and the option acquisition rate while referring to past data and external information based on a trend analysis result and visualization information. For example, it explains by combining a plurality of factors, such as that implementing a large-scale sales promotion campaign in time with a release of a new model is a main cause of an increase in the sales volume, that there is a high possibility that a competitor starting a new optional service is a factor of a decrease in the option acquisition rate, and that a decrease in the sales volume in a specific region is an influence of a region-limited competitor campaign. A specific example of a prompt sentence to be read by generative AI includes “Based on a sales volume transition and an option acquisition rate transition for the latest 6 months, present a hypothesis in natural language regarding a fluctuation factor and a background of the sales volume and the option acquisition rate while referring to past data and external information”. Specifically, the generative AI trend analysis unit dynamically collates the input trend data with information of an external knowledge base using a cross-attention mechanism. The generative AI trend analysis unit vectorizes an external news article and a press release of a competitor and stores them in a vector database in advance. The generative AI trend analysis unit executes a similarity search on the vector database using a feature vector extracted from the trend data as a query. Input data to the generative AI trend analysis unit is a context vector of the trend analysis result and an embedding vector of the searched external knowledge. A specific example of the input data to the generative AI trend analysis unit includes an internal state vector indicating a decrease in the sales volume and a text vector indicating campaign information of a competitor. Output data from the generative AI trend analysis unit is a token sequence of a hypothesis text explaining a causal relationship. A specific example of the output data from the generative AI trend analysis unit includes a sentence in natural language indicating that a specific event is a cause. The hypothesis text output by the generative AI trend analysis unit is used as a constraint condition for determining a direction of a measure in a subsequent plan formulation step. The generative AI trend analysis unit adopts a retrieval-augmented generation architecture to perform inference based on the latest facts independent of internal parameters of a model. The generative AI trend analysis unit internally executes a self-verification prompt for the generated hypothesis and automatically checks whether there is a logical contradiction. The generative AI trend analysis unit thereby exhibits a technical effect of realizing advanced causal inference like a human on a computer, not limited to merely pointing out a correlation. A specific application field of the generative AI trend analysis unit includes a root cause analysis system of an incident in cybersecurity. The generative AI trend analysis unit connects traces of an attack from a plurality of system logs and automatically generates a hypothesis of an intention and an intrusion route of an attacker. The generative AI trend analysis unit can also adopt a configuration of learning a relationship between entities by a graph convolutional network using a knowledge graph. The generative AI trend analysis unit thereby accurately models a more complex and multi-stage causal relationship.

Step 4: Demand Forecasting and Automatic Generation of Plan Proposal by Generative AI A plan formulation unit on the server automatically generates demand forecasting for the next month and thereafter and a specific plan proposal using generative AI based on an analysis result and visualization information of the trend analysis unit. For example, it automatically constructs a linear regression or a time-series forecasting model based on time-series data, and predicts a sales volume and the number of optional service acquisitions for the next month, the next quarter, and the next fiscal year with high accuracy. Based on a prediction result, it automatically generates a plurality of specific measures, such as recommending increasing inventory by 20% because the sales volume is expected to increase next month, that it is effective to implement cross-selling training for sales staff because the option acquisition rate is in a downward trend, that it is desirable to plan a region-limited sales promotion campaign because the sales volume is sluggish in a specific region, that it is effective to increase a web advertisement budget to strengthen sales in an online channel, and that an improvement in the option acquisition rate can be expected by implementing a free trial campaign of an optional service in time with a release of a new model, and also presents a priority, an implementation timing, an expected effect, a necessary resource, a cost estimate, a risk factor, and the like together. A specific example of a prompt sentence to be read by generative AI includes “Based on time-series data of a sales volume and the number of optional service acquisitions for the latest 12 months, predict a sales volume and the number of optional service acquisitions for the next month, automatically generate a plurality of specific plan proposals such as inventory securing, sales staff allocation, a sales promotion campaign, and a cross-selling measure based on a prediction result, and present a priority and an expected effect together”. Specifically, the plan formulation unit connects an autoregressive time-series forecasting model and a reinforcement learning agent as a pipeline. The plan formulation unit quantifies uncertainty of prediction using a Monte Carlo dropout method when predicting a future data point from a past data point. The plan formulation unit calculates an action-value function that maximizes an expected reward based on the predicted probability distribution. Input data to the plan formulation unit is a past time-series tensor and an embedding vector of the hypothesis generated in the factor analysis step. A specific example of the input data to the plan formulation unit includes a numerical array indicating a past sales performance and a text vector indicating a competitor trend. Output data from the plan formulation unit is structured data including a future predicted value vector and a parameter group of a recommended measure. A specific example of the output data from the plan formulation unit includes a floating-point number indicating the number of sales predictions for the next month and a numerical matrix indicating a budget allocation of a measure. The structured data output by the plan formulation unit is transmitted to the user interface unit and rendered on the dashboard. The plan formulation unit iteratively updates a weight parameter so as to minimize a loss function of the prediction model using a gradient descent method. The plan formulation unit integrates prediction results by a plurality of different algorithms by ensemble learning to offset a bias of a single model. The plan formulation unit thereby brings about a technical effect of automating mathematically the most valid decision-making in a highly uncertain business environment. A specific application field of the plan formulation unit includes a yield prediction and an automatic generation system of an optimal pesticide spraying plan in an agricultural field. The plan formulation unit predicts a future growth status from weather data and soil sensor data and calculates an optimal resource allocation. The plan formulation unit can also adopt a configuration of executing millions of simulations in a virtual space in cooperation with digital twin technology to extract an optimal plan proposal. The plan formulation unit thereby completely reduces a cost of trial and error in the real world to zero.

Step 5: Information presentation and interaction by a user interface. A user interface unit on a terminal presents a trend analysis result, visualization information, a plan proposal, and the like transmitted from a server to a user. For example, a sales volume transition graph, an option acquisition rate graph, an analysis comment in natural language by generative AI, a list of plan proposals, a priority and an implementation schedule of a measure, a simulation result of an expected effect, and the like are collectively displayed on a dashboard screen on the terminal, so that the user can easily grasp a current situation and make a decision. The user can also specify conditions such as an analysis target period, a target region, a target product, a sales channel, and a type of measure from the terminal, transmit a request to the server, execute trend analysis and plan formulation again on the server side, and return a result thereof to the terminal in real time. By the user selecting a measure desired to be implemented from the plan proposals and transmitting feedback to the server, it is also possible to reflect the feedback in the next and subsequent analysis and plan formulation. Specifically, the user interface unit adopts an event-driven programming model and asynchronously executes a callback function for a user operation. The user interface unit parses data in a JSON format received from the server and updates an internal state tree. The user interface unit detects a change in the state tree and executes a difference calculation algorithm of a virtual document object model. Input data to the user interface unit is an event object based on a hardware interrupt signal generated from an input device of the user. Specific examples of the input data to the user interface unit include XY coordinates of a mouse pointer on a screen and an identifier of a clicked button. Output data from the user interface unit is an HTTP request payload transmitted to a RESTful API endpoint of the server. Specific examples of the output data from the user interface unit include a JSON character string including an ID of a measure selected by the user and a changed parameter value. The request output by the user interface unit is received by a controller module on the server side and triggers a subsequent recalculation process. The user interface unit directly calls a graphics API of the terminal to smoothly draw a scatter plot or a three-dimensional surface model having a large number of data points at sixty frames per second. The user interface unit uses a local cache mechanism to hold frequently accessed data in a memory of the terminal, thereby reducing unnecessary communication to the server. The user interface unit thereby exhibits a technical effect of realizing an extremely responsive operational feeling while suppressing consumption of a network bandwidth. A specific application field of the user interface unit includes an ultra-high-speed market data visualization terminal on a trading floor of a financial institution. The user interface unit reflects a stock price and an exchange rate fluctuating in milliseconds on a screen without delay to support an instantaneous judgment of a trader. The user interface unit can also adopt a configuration in which a voice recognition engine is incorporated to convert a user's utterance into text and correspond to a query input in natural language. The user interface unit thereby enables a hands-free data analysis operation even in an environment where a keyboard or a mouse cannot be used.

### Specific Use Case

For example, in a sales department in charge of selling mobile terminals, using the system of the present invention, a market trend data acquisition unit automatically collects time-series data regarding a sales volume of mobile terminals and the number of optional service acquisitions for the latest 24 months, and detailed data by sales channel (store, online, agency, etc.), by region (prefecture, municipality, store unit, etc.), and by product category (smartphone, feature phone, tablet, etc.). Furthermore, related data is also acquired from sales trend data of the entire market provided by an external market research company, public information of competitors, and an internal inventory management system, customer management system, call center system, and the like, and data normalization and cleansing processing are automatically executed. The acquired data includes, for example, monthly, weekly, and daily sales performance, an acquisition history of optional services, a performance for each sales staff, a campaign implementation history, an inventory status, customer attribute information, and the like. Specifically, the system expands these multidimensional data on a memory to construct a multidimensional cube for online analytical processing. The system performs aggregation calculation of data in advance based on a hierarchical structure of each dimension and saves it as a materialized view. The system executes a multidimensional data operation such as slicing and dicing at high speed only by replacing a pointer. Input data to the system is a group of tables of a relational database extracted from each business system. Specific examples of the input data to the system include a transaction table in which a customer ID and a purchase history are linked, and a product master table. Output data from the system is a feature amount matrix flattened in accordance with an input format of a machine learning model. Specific examples of the output data from the system include a two-dimensional numerical array in which rows indicate dates and columns indicate a sales volume and an inventory quantity of each store. The feature amount matrix output by the system is directly input to a neural network of a trend analysis unit or a plan formulation unit. The system calculates a Levenshtein distance in a process of data cleansing to automatically perform name identification of character string data having notation fluctuation. The system applies a probabilistic multiple imputation method based on a distribution of peripheral data to a missing value to maintain a statistical property of the data. The system thereby brings about a technical effect of integrating a huge amount of siloed internal and external data and fully automatically generating a high-quality data set processable by AI. A specific application field of the system includes a personalized recommendation system in a large-scale e-commerce platform. The system integrates external trend data in addition to a browsing history and a purchase history of a user to recommend an optimal product to each individual user in real time. The system can also adopt a configuration in which a data lake architecture is adopted to accumulate structured data and unstructured data in an inexpensive object storage in their original formats. The system thereby provides a foundation capable of flexibly extracting and utilizing data even for a future unknown analysis need.

A trend analysis unit using generative AI analyzes a transition of a sales volume of mobile terminals and the number of optional service acquisitions with these diverse data as an input, and analyzes, from multiple viewpoints, for example, a period during which the sales volume is increasing steadily, a period during which an option acquisition rate is decreasing, a phenomenon in which the sales volume rapidly increases in a specific month, a difference in trend by sales channel, by region, and by product category, a correlation between the sales volume and the number of optional service acquisitions, and occurrence of a seasonal variation and an abnormal value. Furthermore, the generative AI automatically generates a transition of the sales volume as a bar graph or a line graph, a transition of the option acquisition rate as a heat map, a correlation between the sales volume and the number of optional service acquisitions as a scatter plot, and a comparison by channel, by region, and by product category as a radar chart or a stacked graph, and outputs visualization information in a form that a user can intuitively understand. In addition, the generative AI presents a hypothesis in natural language by combining a plurality of factors, such as “the main factor for the increase in the sales volume is that a large-scale sales promotion campaign was implemented in accordance with a new model release timing” and “there is a high possibility that a competitor starting a new optional service is a factor for the decrease in the option acquisition rate”, regarding a factor for the rapid increase in the sales volume and a background of the decrease in the option acquisition rate, while referring to past data and external information. Specifically, the system adopts a distributed computing architecture having a plurality of computing nodes. The server is equipped with a plurality of dedicated computing processors for executing large-scale parallel computing. The trend analysis unit using generative AI receives a multidimensional time-series tensor as input data. The input tensor includes elements such as a store identifier, a product identifier, a timestamp, a sales volume, and the number of optional service acquisitions. The number of dimensions of the input tensor has a three-dimensional structure of a batch size, a sequence length, and the number of feature amounts. Specific examples of the input data include a one-dimensional array indicating a daily sales volume for the past thirty days and a two-dimensional matrix indicating an option acquisition rate for each store. The trend analysis unit using generative AI executes normalization processing on the input data. The processing unit automatically complements a missing value by a linear interpolation algorithm. The trend analysis unit using generative AI includes an ensemble architecture of a large language model and a time-series analysis model. The time-series analysis model adopts a long short-term memory network. The long short-term memory network dynamically updates a past hidden state using a forget gate and an input gate. The large language model adopts a transformer architecture having a self-attention mechanism. The self-attention mechanism calculates a degree of relevance among respective elements in an input sequence in parallel. The trend analysis unit using generative AI projects a feature amount vector extracted from time-series data onto a prompt space of the large language model. The trend analysis unit using generative AI generates a parameter vector for visualization and a natural language token sequence as output data. A format of the output data is a probability distribution vector indicating an appearance probability of each word. The output value includes a score indicating a probability that a specific factor contributed to an increase in the sales volume. Specific examples of the output data include numerical data indicating that a probability that campaign implementation is a factor is eighty-five percent and a coordinate vector indicating drawing coordinates of a graph. The trend analysis unit using generative AI transfers an output result to a subsequent processing module. The subsequent processing module extracts only a factor whose probability score exceeds a predetermined threshold value. The subsequent processing module transmits the extracted factor to a user interface unit. With this configuration, the system completely eliminates manual analysis by a human. The system calculates a non-linear correlation in a high-dimensional space at high speed. The system significantly shortens a calculation time of analysis processing. The system realizes efficiency improvement of data management and reduction of a memory usage amount. The present technology is extremely useful in use cases such as store operation of a telecommunications carrier and sales strategy formulation of a consumer electronics retailer.

A plan formulation unit automatically generates demand forecasting for the next month and thereafter and specific plan proposals using generative AI based on an analysis result and visualization information of a trend analysis unit. For example, a linear regression or a time-series forecasting model is automatically constructed based on time-series data, and a forecasting result such as “a sales volume for the next month is expected to increase by 15% compared to the previous month” or “the number of optional service acquisitions is predicted to continue a trend of maintaining the status quo” is output. Furthermore, based on the forecasting result, a plurality of specific measures are automatically generated, such as “it is recommended to increase inventory by 20% because the sales volume is expected to increase next month”, “it is effective to implement cross-selling training for sales staff because an option acquisition rate is in a decreasing trend”, “it is desirable to plan a region-limited sales promotion campaign because the sales volume is sluggish in a specific region”, “it is effective to increase a web advertising budget to strengthen sales in an online channel”, and “an improvement in the option acquisition rate can be expected by implementing a free trial campaign of an optional service in accordance with a new model release timing”, and a priority, an implementation timing, an expected effect, a necessary resource, a cost estimate, a risk factor, and the like are also presented together. Furthermore, it is also possible to utilize empirical knowledge by learning a past measure implementation history and its effect data, such as “among campaigns implemented in the past, a specific promotion contributed most to the improvement of the option acquisition rate, so it is recommended to implement a similar measure again”. Specifically, the plan formulation unit operates on a computing server equipped with a dedicated inference engine. The plan formulation unit receives a feature amount vector output from the trend analysis unit as input data. The input vector includes numerical data such as a past sales performance, a seasonality index, and an external factor score. The number of dimensions of the input data is a high-dimensional vector ranging from hundreds to thousands of dimensions. Specific examples of the input data include a floating-point array indicating a monthly sales volume for the past twelve months and a probability vector indicating a past success probability of each measure. The plan formulation unit executes dimension reduction processing using principal component analysis on the input data. The plan formulation unit adopts a hybrid forecasting model combining an autoregressive integrated moving average model and a deep neural network. The deep neural network includes a multilayer perceptron and a convolutional layer. The model optimizes a weight of a network using a backpropagation method. A linear combination of a mean square error and a cross-entropy error is used for a loss function of the model. The plan formulation unit generates a probability distribution indicating an expected effect score and a recommendation degree of each measure as output data. A format of the output data is structured data consisting of a pair of a measure identifier and an expected effect score. The output value indicates a predicted value of a sales increase rate when a specific measure is implemented. Specific examples of the output data include a score indicating that a recommendation degree of an inventory increase measure is ninety-two percent and numerical data indicating an expected return on investment of cross-selling training. The plan formulation unit transfers an output result to a subsequent optimization module. The optimization module filters only a measure whose expected effect score exceeds a predetermined threshold value. The optimization module sorts the filtered measures in order of expected effect. With this configuration, the system realizes objective plan formulation that does not depend on human intuition. The system instantaneously searches for an optimal measure from a huge number of combinations. The system reduces a human cost required for plan formulation and improves utilization efficiency of computing resources. The present technology is extremely useful in use cases such as inventory optimization and automatic generation of a marketing measure in a retail industry.

A user interface unit collectively displays a trend analysis result, visualization information, a plan proposal, and the like transmitted from a server on a dashboard screen on a terminal, so that a user can easily grasp a current situation and make a decision. The user can specify conditions such as an analysis target period, a target region, a target product, a sales channel, and a type of measure, transmit a request to the server, execute trend analysis and plan formulation again on the server side, and return a result thereof to the terminal in real time. By the user selecting a measure desired to be implemented from the plan proposals and transmitting feedback to the server, it is also possible to reflect the feedback in the next and subsequent analysis and plan formulation. Furthermore, the user can input performance data after measure implementation from the terminal, and realize effect verification of the measure and automation of a PDCA cycle on the server side. Specifically, the user interface unit is implemented as a lightweight web application operating on a client terminal. The user interface unit receives structured data transmitted from the server as input data. The input data includes a coordinate array for graph drawing, character string data of natural language text, an array of a measure list, and the like. A format of the input data is a data format having a hierarchical key-value structure. Specific examples of the input data include a data point group of an X-axis and a Y-axis of a line graph and a text block including a detailed explanation of each measure. The user interface unit dynamically generates a document object model tree based on the input data. The user interface unit uses hardware acceleration to speed up screen rendering. The user interface unit includes an event listener that monitors a user operation event. The user interface unit vectorizes a condition specification parameter input by the user. The user interface unit generates a recalculation request parameter and a user feedback vector as output data. A format of the output data follows a specific schema required by an application programming interface of the server. The output value includes an identifier and an evaluation score of a measure selected by the user. Specific examples of the output data include an array of filtering conditions limiting a target period to the past six months and numerical data of a five-point evaluation for a specific measure. The user interface unit transmits an output result to the server using an asynchronous communication protocol. The server transfers the received feedback vector to a subsequent reinforcement learning module. The reinforcement learning module uses the feedback vector as a reward signal to finely adjust a weight of a forecasting model. With this configuration, the system realizes an interactive dialogue between the user and artificial intelligence. The system continuously incorporates implicit knowledge of the user as learning data of a model. The system realizes a real-time screen update while minimizing consumption of a communication bandwidth. The present technology is extremely useful in use cases such as a decision-making support dashboard for management and a business support tool for field staff.

Specific examples of a prompt sentence to be read by generative AI include “Based on time-series data regarding a sales volume of mobile terminals and the number of optional service acquisitions for the past 24 months, and detailed data by sales channel, by region, and by product category, perform an increase/decrease trend of the sales volume and the number of optional service acquisitions, a seasonal variation, an abnormal value, a trend comparison by sales channel and by region, and a correlation analysis between the sales volume and the number of optional service acquisitions, extract strengths and weaknesses in natural language, and further generate visualization information such as a graph and a table”, “Based on time-series data regarding a sales volume and the number of optional service acquisitions for the latest 12 months, predict a sales volume and the number of optional service acquisitions for the next month, automatically generate a plurality of specific plan proposals such as inventory securing, sales staff allocation, a sales promotion campaign, and a cross-selling measure based on a forecasting result, and present a priority and an expected effect together”, “Present a hypothesis in natural language regarding a fluctuation factor and a background of a sales volume and an option acquisition rate while referring to past data and external information”, and “Based on effect data of a sales promotion campaign implemented in the past, extract the most effective measure, and generate a proposal for utilizing it in future measure formulation”. Specifically, the system includes an inference engine containing a large language model specialized for natural language processing. The inference engine receives a prompt character string generated by a user or the system as input data. The input data takes a format of a text character string. The inference engine includes a tokenizer that divides the input character string into subword units. The tokenizer converts the character string into an integer index array. The number of dimensions of the input data is a one-dimensional array depending on a length of a prompt. Specific examples of the input data include a token ID corresponding to a word “sales volume” and a sequence of token IDs corresponding to a phrase “time-series data”. The inference engine maps the token ID array to a high-dimensional embedding vector space. The inference engine adopts a transformer architecture having billions to hundreds of billions of parameters. The transformer architecture has a structure in which a plurality of self-attention layers and feed-forward neural network layers are stacked. The self-attention layer calculates a contextual dependency among respective tokens in the prompt. The inference engine generates a probability distribution of a next subsequent token as output data. A format of the output data is a probability vector having the number of dimensions equal to a vocabulary size. The output value indicates a likelihood that each vocabulary will appear next. Specific examples of the output data include a numerical value indicating that an appearance probability of a word “increase” is ninety percent and a numerical value indicating that an appearance probability of a word “decrease” is five percent. The inference engine transfers an output result to a subsequent decoding module. The decoding module selects an optimal token from the probability distribution using a beam search algorithm or a top-p sampling algorithm. The decoding module sequentially combines the selected tokens to generate a final natural language text. With this configuration, the system understands a complex business requirement and generates an appropriate answer. The system realizes flexible and contextual text output that is impossible with rule-based natural language generation. The system dramatically improves inference accuracy by optimizing prompt engineering. The present technology is extremely useful in use cases such as an automatic report generation system and an interactive business assistant.

### Application Example 1

The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment of the present invention will be described more specifically and in detail. The system of the present invention is configured to include a physical store operation data acquisition unit, a generative AI trend analysis unit, an operation plan formulation unit, a user interface unit, a database management unit, an external cooperation unit, and a security management unit, and these respective units operate on a server, and the user interface unit operates on a terminal used by a store manager or staff. Specifically, the system adopts a microservices architecture constructed on a cloud computing environment. The system deploys each functional unit as an independent container. The system automatically manages a life cycle of each container using a container orchestration tool. The system receives time-series data of operation metrics and a resource usage status of the entire system as input data. The input data includes numerical data such as a usage rate of a central processing unit, a memory consumption amount, and a network traffic amount. The number of dimensions of the input data is a multidimensional tensor depending on the number of nodes to be monitored and a metric type. Specific examples of the input data include a time-series array indicating that a processor usage rate of a specific computing node is eighty percent and a floating-point array indicating a query response time of a database. The system applies a moving average filter to the input data to remove noise. The system includes a machine learning model for optimizing resource allocation. The machine learning model adopts a reinforcement learning algorithm. The reinforcement learning algorithm learns an optimal action from a current state of the system based on a Markov decision process. The model generates a scaling instruction vector for each container as output data. A format of the output data is structured data consisting of a pair of a container identifier and an increase/decrease number. The output value indicates a specific numerical value for expanding or reducing a processing capacity of a specific functional unit. Specific examples of the output data include instruction data indicating adding three containers of the generative AI trend analysis unit and instruction data indicating increasing memory allocation of the database management unit by two gigabytes. The system transfers an output result to a subsequent orchestration engine. The orchestration engine dynamically executes reallocation of physical resources in accordance with the instruction vector. With this configuration, the system maintains stable performance even against a sudden access concentration. The system maximizes utilization efficiency of hardware resources and minimizes an operation cost. The system eliminates a single point of failure and realizes high availability and fault tolerance. The present technology is extremely useful in use cases such as an integrated management system of a large-scale chain store and a headquarters system that supervises a plurality of stores.

First, a physical store operation data acquisition unit has a function of automatically collecting diverse data in a physical store in real time or by batch processing. For example, the number of sales for each product, sales by time zone, sales by payment method, the number of returns/exchanges, the number of campaign applications, the number of people passing through a cash register, and the like are acquired from a POS terminal. For example, the number of new acquisitions of point cards and membership services, a visit frequency of an existing member, a customer attribute (age group, gender, purchase history, unit purchase price), questionnaire answer content, a customer satisfaction score, and the like are acquired from a customer management system. For example, service use data such as the number of gift wrapping uses, the number of extended warranty applications, a consumption amount of wrapping materials, and a use status of a service counter is acquired from a service management system. For example, the number of visitors is acquired by a plurality of means such as an entry/exit sensor, a facial recognition camera, the number of uses of a POS cash register, the number of Wi-Fi connected terminals, and beacon detection of a smartphone, and a visitor attribute, a stay time, a peak time zone, and the like are also grasped. For example, a staff allocation status, a work record, a sales performance for each staff, a customer service evaluation, a break acquisition status, an overtime hour, and the like are acquired from a staff shift management system. For example, an implementation history of a promotional event or a campaign, the number of event participants, sales by event, a customer attribute by event, an event questionnaire result, and the like are acquired from an event management system. For example, weather information (temperature, precipitation, weather type, warning issuance), neighborhood event information (sports tournament, concert, local festival, traffic regulation), traffic information (the number of passengers getting on and off at a nearest station, a bus operation status, a parking lot congestion degree), and the like are acquired from an external API. For example, an inventory status for each product, a replenishment history, the number of remaining orders, expiration date management, an inventory count result, a disposal history, and the like are acquired from an inventory management system. For example, an operation status of a refrigerating/freezing facility, an operation status of lighting/air conditioning, a facility failure history, an energy consumption amount, and the like are acquired from a store facility management system. These data are acquired at various granularities such as daily, weekly, monthly, quarterly, and yearly, and data normalization and cleansing processing are automatically performed. For example, an abnormal value and a missing value are automatically detected, and complementation and exclusion processing are implemented. For example, data can be acquired and accumulated from various viewpoints, such as by sales channel (store, online, agency, etc.), by region (prefecture, municipality, store unit, etc.), by product category (food, clothing, home appliance, miscellaneous goods, etc.), and by period (daily, weekly, monthly, quarterly, yearly, etc.). Furthermore, for example, data of a plurality of stores can be integrated to enable a trend of an entire chain and an inter-store comparison. Specifically, the physical store operation data acquisition unit is connected to each sensor and system via a distributed message queuing system. The acquisition unit receives a raw data stream in a wide variety of formats as input data. The input data includes text data in a JSON format, image data in a binary format, a comma-separated text file, and the like. The number of dimensions of the input data depends on a type of data source and is extremely non-uniform. Specific examples of the input data include a feature point vector of a visitor acquired from a facial recognition camera and a one-dimensional array of temperature per minute acquired from a temperature sensor. The acquisition unit executes an extract, transform, load pipeline. The pipeline performs schema validation and type conversion on the input data. The acquisition unit executes complementation processing based on a K-nearest neighbor method as a missing value complementation algorithm. The acquisition unit adopts an isolation forest as an outlier detection algorithm to identify an abnormal data point. The acquisition unit generates a normalized multidimensional tensor as output data. A format of the output data is a structured tensor in which all data sources are combined with a common timestamp and store identifier. The output value includes a standardized numerical value of each feature amount. Specific examples of the output data include an array of a sales amount scaled so that a mean is zero and a variance is one, and a binary vector obtained by one-hot encoding a categorical variable. The acquisition unit transfers an output result to a subsequent data warehouse module. The data warehouse module persists tensor data in a storage in a column-oriented format. With this configuration, the system integrates siloed store data to construct a single reliable information source. The system distributes a calculation load required for data preprocessing to realize real-time data processing. The system provides a high-quality data foundation for a subsequent artificial intelligence model to perform highly accurate inference. The present technology is extremely useful in use cases such as construction of a smart store and operation management of an unmanned store.

A generative AI trend analysis unit performs multifaceted and hierarchical trend analysis using generative AI with the acquired diverse data as an input. For example, a sales transition for each product, a service use transition, and a visitor number transition are analyzed in time series, and an increase/decrease trend, a seasonal variation, periodicity, a sudden fluctuation, detection of an abnormal value, a trend comparison by sales channel, by region, and by product category, an increase/decrease factor of sales and service use, a correlation analysis among a plurality of indicators, and the like are implemented. For example, trends are extracted, such as the number of sales of product A is increasing steadily in the latest 30 days, the number of sales of product B is in a decreasing trend, the number of point card acquisitions is stable, the number of gift wrapping uses is rapidly increasing on a specific weekend or holiday, the number of visitors is small overall, and the number of visitors is concentrated in a specific time zone. For example, regarding an increase/decrease factor of sales and service use, the generative AI explains in natural language by combining a plurality of factors, such as “an increase in sales of product A is an effect of a new sales promotion campaign”, “an increase in use of gift wrapping is linked to an event timing such as Mother's Day or Christmas”, “a decrease in the number of visitors is an influence of bad weather or a neighborhood event”, “sales in a time zone in charge of a specific staff are high”, and “a visit frequency of a specific customer segment is increasing”. Furthermore, a transition of a sales volume is automatically generated as a bar graph or a line graph, a transition of an option acquisition rate as a heat map, a correlation between the sales volume and the number of optional service acquisitions as a scatter plot, and a comparison by channel, by region, and by product category as a radar chart or a stacked graph, and visualization information is output in a form that a user can intuitively understand. Furthermore, the generative AI automatically extracts strengths and weaknesses in natural language, and outputs them in a form that a field person in charge or a manager can immediately understand, such as “it is a strength that the number of sales of product A is stably increasing”, “it is a task that the number of gift wrapping uses is in a decreasing trend”, “a staff shortage occurs in a specific time zone”, and “reach to a specific customer segment is weak”. Furthermore, for example, a hypothesis can be generated regarding a fluctuation factor of a sales transition and a service use transition while referring to past data and external information, and explained by combining a plurality of factors, such as “the main factor for the increase in the sales volume is that a large-scale sales promotion campaign was implemented in accordance with a new model release timing”, “there is a high possibility that a competitor starting a new optional service is a factor for the decrease in the option acquisition rate”, “the number of visitors tends to decrease when weather deteriorates”, and “sales of a specific product increase when a neighborhood event is held”. Specifically, the generative AI trend analysis unit operates on a computing cluster equipped with a dedicated tensor computing processor. The analysis unit receives a normalized multidimensional time-series tensor output from the data acquisition unit as input data. The input tensor has a three-dimensional structure having three axes of a store, time, and a feature amount. Specific examples of the input data include an array indicating the number of visitors per hour in each store for the past ninety days and a matrix indicating a sales composition ratio by category of each product. The analysis unit applies a graph neural network to the input tensor. The graph neural network learns a geographical relationship between stores and a similarity of a customer segment as a weight of an edge. The analysis unit adopts a transformer model having a self-attention mechanism for time-series analysis. The transformer model simultaneously captures dependencies of different time scales using a multi-head attention mechanism. The analysis unit generates a contribution degree score of each factor and a token sequence of natural language text as output data. A format of the output data is a vector consisting of a pair of a factor identifier and a contribution degree score, and a probability distribution of the generated text. The output value includes a numerical value indicating a magnitude of an influence that a specific event has on a sales fluctuation. Specific examples of the output data include numerical data indicating that a score that bad weather contributed to a decrease in the number of visitors is zero point eight five, and character string data of text summarizing strengths and tasks. The analysis unit transfers an output result to a subsequent plan formulation unit. The plan formulation unit extracts only a factor whose contribution degree score exceeds a predetermined threshold value and uses it as an input for plan generation. With this configuration, the system automatically extracts a non-linear correlation among complex variables that is difficult for a human to discover. The system promotes understanding of field staff who do not have specialized knowledge by presenting an analysis result in natural language. The system dramatically shortens a time required for data analysis from several days to several seconds. The present technology is extremely useful in use cases such as trend analysis of an apparel store and demand forecasting of a supermarket.

The operation plan formulation unit performs demand forecasting for the number of sales of each product, the number of service uses, the number of visitors, and the like for the next day or the next week and thereafter using generative AI based on an analysis result and visualization information of the trend analysis unit, and automatically generates a plurality of diverse and specific operation plan proposals related to physical store operation, such as inventory replenishment, staff shift optimization, promotional event implementation, a cross-selling measure, a layout change, targeted advertisement distribution, a staff education plan, a measure by customer attribute, prioritization of measures and a proposal of an implementation timing, a simulation of an expected effect, a necessary resource and a cost estimate, extraction of a risk factor, and an effect verification plan after measure implementation, according to a forecasting result. For example, the operation plan formulation unit automatically constructs a linear regression or a time-series forecasting model based on time-series data, and outputs specific numerical forecasting such as “the number of sales of product A for the next day is expected to increase by 10% from today”, “the number of point card acquisitions is maintained as it is”, “the number of visitors is highly likely to decrease due to the influence of bad weather”, and “an increase in staff is necessary because the number of visitors concentrates in a specific time zone”. Furthermore, based on the forecasting result, the operation plan formulation unit presents a plurality of specific measure proposals such as “recommending replenishing the inventory of product A more than usual when an increase in sales of product A is predicted”, “recommending implementing a point card enrollment promotion campaign when the number of point card acquisitions is sluggish”, “recommending implementing a customer attraction event or a time sale when the number of visitors is in a decreasing trend”, “recommending an increase in gift wrapping staff and additional ordering of wrapping materials when an increase in use of gift wrapping is predicted”, “adjusting a staff shift in a specific time zone to optimize personnel allocation at a peak time”, “distributing a targeted advertisement to a specific customer segment”, “changing a layout in accordance with the release of a new product”, and “formulating a staff education plan to strengthen a cross-selling measure”. Furthermore, in cooperation with a staff shift management system, a staff allocation plan can also be automatically optimized according to the predicted number of visitors and the predicted number of sales. Furthermore, for example, it is also possible to learn a past measure implementation history and its effect data, and utilize empirical knowledge such as “since a specific promotion contributed most to the improvement of the option acquisition rate among campaigns implemented in the past, it is recommended to implement the same measure again” and “planning a new event with reference to a day of the week and a time zone in which a customer attraction effect was high in a past event”. Furthermore, for example, a priority and an implementation timing of a measure, an expected effect, a necessary resource, a cost estimate, a risk factor, an effect verification plan after measure implementation, and the like are also automatically generated and presented to a store manager or a staff terminal in an easy-to-understand manner. Specifically, this operation plan formulation unit operates on an inference server including a reinforcement learning agent. This formulation unit receives a factor contribution score and a time-series tensor of demand forecasting output from the trend analysis unit as input data. This input data includes numerical data such as the predicted number of sales of each product, the predicted number of visitors, and a staff skill matrix. The number of dimensions of this input data is a high-dimensional vector covering all products and all staff in the store. Specific examples of this input data include a one-dimensional array indicating the predicted number of visitors by time zone for the next day and a two-dimensional matrix indicating a customer service skill level of each staff member. This formulation unit executes an optimization algorithm based on a Markov decision process. This formulation unit searches for an optimal combination of measures using a policy gradient method. This formulation unit calculates a solution satisfying an upper limit of staff working hours and a limitation of inventory space using a constrained optimization solver. This formulation unit generates an optimal measure vector and an expected reward score as output data. The format of this output data is structured data including parameters such as a type of measure, an implementation time, a target product, and an assigned staff member. This output value indicates a predicted profit and an improvement range of customer satisfaction when each measure is executed. Specific examples of this output data include a shift change parameter indicating that the number of staff is increased by two between 2:00 p.m. and 4:00 p.m. and an inventory replenishment parameter indicating that the number of orders for a specific product is increased by 50. This formulation unit transfers an output result to a subsequent user interface unit and an external linkage unit. This external linkage unit automatically transmits the inventory replenishment parameter to a logistics system. With this configuration, this system realizes data-driven store operation that does not depend on personal experience or intuition. This system calculates optimal resource allocation that maximizes profit under complex constraint conditions at high speed. This system automates plan formulation work and significantly reduces a business burden on a store manager. This technology is extremely useful in use cases such as an automatic ordering system for a convenience store and automatic shift creation for a restaurant.

The user interface unit collectively displays a trend analysis result, visualization information, an operation plan proposal, and the like transmitted from the server on a dashboard screen on the terminal, enabling a user to easily grasp the current situation and make a decision. For example, a sales volume transition graph, a service use transition graph, an analysis comment in natural language by generative AI, a list of operation plan proposals, a priority and an implementation schedule of a measure, a simulation result of an expected effect, and the like are collectively displayed. The user can transmit a request to the server by designating conditions such as an analysis target period, a target region, a target product, a sales channel, and a type of measure, execute trend analysis and plan formulation again on the server side, and return the result to the terminal in real time. By the user selecting a measure desired to be implemented from the operation plan proposals and transmitting feedback to the server, it is also possible to reflect the feedback in the next and subsequent analysis and plan formulation. Furthermore, the user can input performance data after measure implementation from the terminal, and realize effect verification of the measure and automation of a PDCA cycle on the server side. For example, sales, the number of visitors, customer satisfaction, a staff operation status, and the like after measure implementation can be automatically monitored, a measure having a high effect can be automatically extracted, and the measure can be reflected in the next and subsequent plan formulation. Specifically, this user interface unit is equipped with a high-speed rendering engine using a web graphics library. This user interface unit receives a measure vector and a visualization data set transmitted from the server as input data. This input data includes vertex coordinates of a graph, color information of a polygon, a rendering parameter of text, and the like. The number of dimensions of this input data is a multidimensional array depending on the resolution of the screen and the number of display elements. Specific examples of this input data include a floating-point array indicating spatial coordinates of each plot of a three-dimensional scatter plot and a list of integer values indicating the priority of measures. This user interface unit manages a state of the screen based on a reactive programming paradigm. This user interface unit efficiently executes differential updating of the screen using a virtual document object model. This user interface unit captures an event such as a user's touch operation or mouse click. This user interface unit generates vectorized data of user feedback as output data. The format of this output data is a JSON format payload including an identifier of a measure selected by the user and an input performance value. This output value includes an adoption flag for a specific measure and a numerical value indicating an actual sales increase amount after implementation. Specific examples of this output data include a Boolean value indicating that measure A has been adopted and an integer value indicating a customer satisfaction score after measure implementation. This user interface unit transmits an output result to the server via a secure communication channel. This server adds the received feedback data to a data set for fine-tuning the model. With this configuration, this system smoothly visualizes a large amount of data without delay. This system enables intuitive operation by the user and accelerates a learning loop of the system. This system effectively utilizes calculation resources on the client side and distributes a load on the server. This technology is extremely useful in use cases such as an integrated dashboard for an area manager who overviews the situations of a plurality of stores.

The database management unit is responsible for accumulation, management, search, backup, restoration, access authority management, and the like of various data, and centrally manages, for example, sales performance data, service use data, a measure implementation history, a user operation history, an external data linkage history, and the like. A plurality of types of databases, such as a relational type, a NoSQL type, and a time-series database type, can be combined and operated according to an application. Maintenance of data consistency, high-speed search, data encryption, recording of an access log, and the like are also implemented. For example, data can be searched and extracted from various viewpoints such as by store, by product, by period, by customer attribute, and by measure. Specifically, this database management unit operates on a cluster system adopting a distributed storage architecture. This management unit receives normalized data and a query character string transmitted from each functional unit as input data. This input data includes a command character string of a structured query language and a data object in a key-value format. The number of dimensions of this input data depends on a schema of a record to be stored. Specific examples of this input data include a character string of a SELECT statement requesting sales data for the past one month of a specific store and a payload of an INSERT statement for storing a new measure history. This management unit dynamically generates an execution plan of the input query using a query optimizer. This management unit optimizes a data search speed using a B-tree algorithm and a hash index. This management unit automatically executes sharding of the database according to an increase in data amount. This management unit generates a response data set to the query as output data. The format of this output data is an array of records according to the requested schema or a status code indicating success of processing. This output value includes a set of specific numerical values and character strings matching a search condition. Specific examples of this output data include single numerical data indicating a total value of a sales amount and a two-dimensional array including 100 customer records matching a condition. This management unit returns an output result to a requesting module via a network. This requesting module expands the received data set on a memory and uses it for subsequent calculation processing. With this configuration, this system safely and efficiently manages petabyte-class large-scale data. This system executes complex aggregation processing with a response time in milliseconds. This system completely prevents data loss at the time of a hardware failure by data redundancy. This technology is extremely useful in use cases such as a core system of a large-scale retail business in which an enormous amount of transactions occur.

The external linkage unit is responsible for data linkage with an external system and an external service, and connects with diverse external systems such as an API of a market research company, acquisition of public information of a competitor, inventory linkage with a logistics system, linkage with an advertisement distribution system, data linkage with an external BI tool, a weather information API, a traffic information API, and an event information API by an API, batch linkage, file linkage, or the like. Data conversion and format conversion at the time of external linkage, authentication/authorization processing, error detection and retry processing, and the like are also implemented. For example, external weather information is acquired and reflected in the prediction of the number of visitors, an inventory replenishment plan is automated in cooperation with a logistics system, and a targeted advertisement is automatically distributed in cooperation with an advertisement distribution system. Specifically, this external linkage unit includes an API gateway that operates independently as a microservice. This linkage unit receives data in a JSON or XML format transmitted from an external system as input data. This input data includes an HTTP response body from an external web service. The number of dimensions of this input data is a variable-length data structure depending on specifications of the external system. Specific examples of this input data include a one-dimensional array indicating an hourly precipitation probability acquired from a server of the Japan Meteorological Agency and a set of key-value pairs indicating the current inventory number of each product acquired from a logistics system. This linkage unit executes data schema conversion processing on the input data. This linkage unit establishes a secure session with the external system using an OAuth authentication protocol. This linkage unit prevents an excessive request to an external API using a rate limit control algorithm. This linkage unit executes automatic retry processing using an exponential backoff algorithm when a communication error occurs. This linkage unit generates tensor data converted into an internal standard format as output data. The format of this output data is a structured tensor that can be directly processed by other modules in the system. This output value includes a numerical value and a categorical variable obtained by normalizing information acquired from the outside. Specific examples of this output data include a floating-point number obtained by normalizing a precipitation probability to a range from zero to one and an array of integer values representing the number of inventories. This linkage unit transfers an output result to a subsequent database management unit or data acquisition unit. This database management unit stores the received tensor data in a predetermined table. With this configuration, this system reflects a change in an external environment in an internal forecasting model in real time. This system absorbs a difference in different data formats and maintains loose coupling between systems. This system prevents a failure of an external system from spreading to an internal system. This technology is extremely useful in use cases such as optimization of an entire supply chain and automation of dynamic pricing.

The security management unit is responsible for security of the entire system, and implements multilayered security measures such as user authentication/authorization, communication encryption, unauthorized access detection, data falsification detection, access authority management, audit log recording, malware countermeasures, vulnerability diagnosis, and data masking. For example, it corresponds to advanced security requirements required for physical store operation, such as dividing access authority between a store manager and staff to restrict access to important data and functions, encrypting a communication path to prevent eavesdropping and falsification from the outside, and periodically diagnosing vulnerability of the entire system to apply the latest security patch. Specifically, this security management unit includes a dynamic policy evaluation engine based on a zero trust architecture. This management unit receives network traffic data and a user's access request as input data. This input data includes information such as a transmission source IP address, a path of a requested resource, and a byte sequence of a payload. The number of dimensions of this input data is a one-dimensional byte array depending on header information of a packet and a payload size. Specific examples of this input data include a request packet including a query to a specific database table and an encrypted character string including authentication information from a login screen. This management unit executes packet analysis using an anomaly detection model on the input data. This anomaly detection model adopts a deep learning network using an autoencoder and scores a deviation from a normal communication pattern. This management unit encrypts and decrypts stored data and communication data using an Advanced Encryption Standard algorithm. This management unit verifies a user's authority using a role-based access control algorithm. This management unit generates a token indicating access permission or denial and an anomaly score as output data. The format of this output data is a character string in a JSON Web Token format or binary data of an alert signal. This output value includes a Boolean value indicating success or failure of authentication and a percentage indicating a possibility of an attack. Specific examples of this output data include a character string of an authentication token for which an expiration date is set and numerical data indicating that an anomaly score is 95 percent. This management unit transfers an output result to a subsequent network control module. This network control module immediately disconnects a corresponding session when the anomaly score exceeds a threshold value. With this configuration, this system prevents an internal crime and a cyberattack from the outside. This system minimizes a leakage risk of confidential data and complies with compliance. This system realizes strong defense while minimizing a communication delay due to a security check. This technology is extremely useful in use cases such as a membership system and a payment linkage system of a retail business handling personal information of customers.

As described above, the system of the present invention collects and analyzes diverse operation data of a physical store in real time, automatically generates an operation plan such as inventory replenishment, a staff shift, a promotional event, a cross-selling measure, a layout change, targeted advertisement distribution, a staff education plan, and a measure by customer attribute through trend analysis, factor analysis, and demand forecasting by generative AI, and presents the operation plan to a store manager or a staff terminal in an easy-to-understand manner, thereby speeding up decision-making in the field and providing advanced value in all aspects of physical store operation, such as maximization of sales and customer satisfaction, business efficiency improvement, risk reduction, work style reform of staff, and improvement of customer experience. Furthermore, for example, in the future, a system design capable of flexibly responding to various expansions such as an interactive interface by voice input or natural language, expansion of external data linkage, API linkage with a system of another company, optimization for a mobile terminal, security enhancement, multi-tenant support, an automatic learning/self-optimization function by AI, overall optimization by inter-store linkage, and automatic calculation of a sustainability indicator can be adopted. Specifically, this system includes an autonomous control module implementing a self-optimization algorithm. This control module receives operation metrics of the entire system and time-series data of key performance indicators of each store as input data. This input data includes numerical data such as a processor usage rate, a memory consumption amount, a sales achievement rate, and a customer satisfaction score. The number of dimensions of this input data is a multidimensional tensor proportional to the number of nodes to be monitored and the number of stores. Specific examples of this input data include a one-dimensional array indicating a sales achievement rate for the past one week of all stores and a vector indicating a current load status of each calculation node. This control module executes resource allocation optimization processing using reinforcement learning on the input data. This control module executes a horizontal scaling algorithm that dynamically increases or decreases the number of containers according to a load status of the system. This control module generates a scaling instruction vector and an update parameter of a system configuration as output data. The format of this output data is a description format of a setting file that can be interpreted by an orchestration tool. This output value includes an integer value indicating the number of containers to be additionally started and a capacity of a memory to be allocated. Specific examples of this output data include a setting value indicating that the number of replicas of an inference engine is increased to five and a flag indicating that a priority of specific batch processing is lowered. This control module transfers an output result to a subsequent infrastructure management layer. This infrastructure management layer automatically executes provisioning of a virtual machine and a change of network routing in accordance with an instruction. With this configuration, this system always maintains optimal performance without intervention of an operation manager. This system can scale out without code modification for a future increase in data amount and functional expansion. This system eliminates waste of calculation resources and optimizes an operation cost of a cloud infrastructure. This technology is extremely useful in use cases such as an integrated foundation of a large-scale franchise chain expanding nationwide and a platform that cross-sectionally manages a plurality of brands.

### System Configuration

The system according to the present embodiment includes a physical store operation data acquisition unit, a generative AI trend analysis unit, an operation plan formulation unit, a user interface unit, a database management unit, an external linkage unit, and a security management unit. The physical store operation data acquisition unit has a function of automatically collecting diverse operation data in a physical store in real time or by batch processing, and acquires, for example, the number of sales for each product, sales by time zone, sales by payment method, the number of returns/exchanges, the number of campaign applications, the number of people passing through a cash register, and the like from a POS terminal, acquires the number of new acquisitions of point cards and membership services, a visit frequency of existing members, customer attribute information, questionnaire answer contents, a customer satisfaction score, and the like from a customer management system, acquires the number of gift wrapping uses, the number of extended warranty applications, a consumption amount of wrapping materials, a use status of a service counter, and the like from a service management system, acquires the number of visitors, visitor attributes, a stay time, a peak time zone, and the like from an entry/exit sensor, a face recognition camera, the number of uses of a POS cash register, the number of Wi-Fi connected terminals, beacon detection of a smartphone, and the like, acquires a staff allocation status, a work record, a sales performance for each staff member, a customer service evaluation, a break acquisition status, overtime hours, and the like from a staff shift management system, acquires an implementation history of a promotional event and a campaign, the number of event participants, sales by event, customer attributes by event, an event questionnaire result, and the like from an event management system, acquires weather information, neighborhood event information, traffic information, and the like from an external API, acquires an inventory status for each product, a replenishment history, the number of remaining orders, expiration date management, an inventory result, a disposal history, and the like from an inventory management system, acquires an operation status of refrigeration/freezing equipment, an operation status of lighting/air conditioning, an equipment failure history, an energy consumption amount, and the like from a store equipment management system, acquires these data at various granularities such as daily, weekly, monthly, quarterly, and yearly, and also enables data normalization and cleansing processing, automatic detection and complementation/exclusion processing of an abnormal value and a missing value, data acquisition and accumulation from diverse viewpoints such as by sales channel, by region, by product category, and by period, and grasping of a trend of an entire chain by data integration of a plurality of stores. Specifically, this physical store operation data acquisition unit cooperates with an edge computing device equipped with a stream processing engine. This acquisition unit receives a raw data stream continuously transmitted from each sensor and system as input data. This input data is a sequence of packet data including a time stamp, a sensor identifier, and a measurement value. The number of dimensions of this input data is an infinite-length time-series stream depending on the number of connected devices. Specific examples of this input data include a hash value of a media access control address of a smartphone detected by a beacon and an array of voltage values output by a temperature sensor in milliseconds. This acquisition unit executes real-time aggregation processing using a sliding window method on the input data. This acquisition unit smooths noise of sensor data using a Kalman filter. This acquisition unit generates a normalized feature amount vector as output data. The format of this output data is a fixed-length high-dimensional vector divided at regular time intervals. This output value includes an aggregated numerical value such as the number of visitors per minute and an average stay time. Specific examples of this output data include a histogram vector indicating the number of visitors by age group in a specific time zone and a score in a range from zero to one indicating a degree of congestion in a store. This acquisition unit transfers an output result to a subsequent in-memory data grid. This in-memory data grid caches the feature amount vector and responds to a high-speed read request from a subsequent analysis unit. With this configuration, this system efficiently compresses an enormous amount of raw data and suppresses consumption of a network bandwidth. This system reduces a calculation load of a subsequent artificial intelligence model while maintaining freshness of data. This system enables real-time situation grasping and supports execution of a highly immediate measure. This technology is extremely useful in use cases such as flow line analysis in a large-scale commercial facility and congestion mitigation measures at an event venue.

The generative AI trend analysis unit performs multifaceted and hierarchical trend analysis using generative AI with the acquired diverse data as an input, and implements, for example, time-series analysis of a sales transition for each product, a service use transition, and a visitor number transition, an increase/decrease trend, a seasonal variation, periodicity, a sudden fluctuation, detection of an abnormal value, a trend comparison by sales channel, by region, and by product category, an increase/decrease factor of sales and service use, a correlation analysis among a plurality of indicators, a trend analysis of a specific time zone and a specific customer segment, and trend extraction of a sales performance and a customer service evaluation for each staff member, extracts trends such as, for example, the number of sales of product A has been steadily increasing over the last 30 days, the number of sales of product B is in a decreasing trend, the number of point card acquisitions is stable, the number of gift wrapping uses rapidly increases on a specific weekend or holiday, the number of visitors is generally small, the number of visitors concentrates in a specific time zone, sales in a time zone in charge of a specific staff member are high, and a visit frequency of a specific customer segment is increasing, explains an increase/decrease factor of sales and service use in natural language by combining a plurality of factors such as “an increase in sales of product A is an effect of a new promotional campaign”, “an increase in use of gift wrapping is linked to an event timing such as Mother's Day or Christmas”, “a decrease in the number of visitors is an influence of bad weather or a neighborhood event”, “sales in a time zone in charge of a specific staff member are high”, and “a visit frequency of a specific customer segment is increasing”, automatically generates a transition of a sales volume with a bar graph or a line graph, a transition of an option acquisition rate with a heat map, a correlation between the sales volume and the number of optional service acquisitions with a scatter plot, and a comparison by channel, by region, and by product category with a radar chart or a stacked graph, outputs visualization information in a form that a user can intuitively understand, automatically extracts strengths and weaknesses in natural language, outputs them in a form that a person in charge in the field or a manager can immediately understand, such as “it is a strength that the number of sales of product A is stably increasing”, “it is a problem that the number of gift wrapping uses is in a decreasing trend”, “a staff shortage occurs in a specific time zone”, and “reach to a specific customer segment is weak”, generates a hypothesis about a fluctuation factor of a sales transition and a service use transition while referring to past data and external information, and can explain it by combining a plurality of factors such as “the main factor of an increase in sales volume is that a large-scale promotional campaign was implemented in accordance with a new model release timing”, “it is highly likely that a competitor starting a new optional service is a factor of a decrease in option acquisition rate”, “the number of visitors tends to decrease when weather deteriorates”, and “sales of a specific product increase when a neighborhood event is held”. Specifically, this generative AI trend analysis unit includes an inference pipeline implementing a multimodal learning model. This analysis unit receives a feature amount vector output from the data acquisition unit and an embedding vector of a past text report as input data. This input data is a complex tensor including both numerical data and natural language data. The number of dimensions of this input data is the sum of the number of dimensions of a numerical feature amount and the number of dimensions of text embedding. Specific examples of this input data include a numerical array indicating the number of sales of each product and a vector representation of text indicating an outline of a past campaign. This analysis unit executes integrated analysis using a cross-attention mechanism on the input data. This analysis unit infers a causal relationship between a fluctuation of numerical data and an event described in text data using a probabilistic graphical model. This analysis unit generates an analysis result tensor and a token sequence of generated text as output data. The format of this output data is a weight vector indicating the importance of a factor and character string data in natural language. This output value includes a percentage indicating a ratio at which each factor contributed to a sales fluctuation and coordinate data for drawing a graph. Specific examples of this output data include a numerical value indicating that a contribution degree of a weather factor is 30 percent and text data in which strengths and problems are itemized. This analysis unit transfers an output result to a subsequent plan formulation unit and user interface unit. This plan formulation unit receives the weight vector as an input and uses it for prediction calculation in the next stage. With this configuration, this system verbalizes a background of a complex event that cannot be explained only by numerical data. This system dramatically improves accuracy and interpretability of analysis by integrally processing heterogeneous data. This system substitutes for analysis work of a data scientist and instantaneously provides an advanced insight. This technology is extremely useful in use cases such as marketing analysis of a new product and trend investigation of a competing store.

The operation plan formulation unit performs demand forecasting for the number of sales of each product, the number of service uses, the number of visitors, and the like for the next day or the next week and thereafter using generative AI based on an analysis result and visualization information of the trend analysis unit, automatically generates a plurality of diverse and specific operation plan proposals related to physical store operation, such as inventory replenishment, staff shift optimization, promotional event implementation, a cross-selling measure, a layout change, targeted advertisement distribution, a staff education plan, a measure by customer attribute, prioritization of measures and a proposal of an implementation timing, a simulation of an expected effect, a necessary resource and a cost estimate, extraction of a risk factor, and an effect verification plan after measure implementation, according to a forecasting result, automatically constructs a linear regression or a time-series forecasting model based on time-series data, for example, outputs specific numerical forecasting such as “the number of sales of product A for the next day is expected to increase by 10% from today”, “the number of point card acquisitions is maintained as it is”, “the number of visitors is highly likely to decrease due to the influence of bad weather”, and “an increase in staff is necessary because the number of visitors concentrates in a specific time zone”, presents a plurality of specific measure proposals based on the forecasting result, such as “recommending replenishing the inventory of product A more than usual when an increase in sales of product A is predicted”, “recommending implementing a point card enrollment promotion campaign when the number of point card acquisitions is sluggish”, “recommending implementing a customer attraction event or a time sale when the number of visitors is in a decreasing trend”, “recommending an increase in gift wrapping staff and additional ordering of wrapping materials when an increase in use of gift wrapping is predicted”, “adjusting a staff shift in a specific time zone to optimize personnel allocation at a peak time”, “distributing a targeted advertisement to a specific customer segment”, “changing a layout in accordance with the release of a new product”, and “formulating a staff education plan to strengthen a cross-selling measure”, automatically optimizes a staff allocation plan according to the predicted number of visitors and the predicted number of sales in cooperation with a staff shift management system, learns a past measure implementation history and its effect data, enables utilization of empirical knowledge such as “since a specific promotion contributed most to the improvement of the option acquisition rate among campaigns implemented in the past, it is recommended to implement the same measure again” and “planning a new event with reference to a day of the week and a time zone in which a customer attraction effect was high in a past event”, and also automatically generates a priority and an implementation timing of a measure, an expected effect, a necessary resource, a cost estimate, a risk factor, an effect verification plan after measure implementation, and the like, and presents them to a store manager or a staff terminal in an easy-to-understand manner. Specifically, this operation plan formulation unit includes a hybrid inference engine combining a constrained optimization solver and a deep learning model. This formulation unit receives an analysis result tensor output from the trend analysis unit as input data. This input data includes numerical data such as a demand forecasting value of each product, a weight vector of a factor, and available working hours of staff. The number of dimensions of this input data is a multidimensional matrix depending on the number of variable groups to be planned. Specific examples of this input data include a one-dimensional array indicating the necessary number of staff in each time zone for the next day and a vector indicating an ordering lead time of each product. This formulation unit executes optimization calculation using mixed integer linear programming on the input data. This formulation unit estimates a success probability of a measure in a similar situation in the past using a deep learning model. This formulation unit generates a plan parameter matrix and an expected effect score as output data. The format of this output data is a structured matrix defining an execution timing, a target, and a resource allocation amount of each measure. This output value includes a numerical value indicating a predicted profit and a cost reduction amount when a specific measure is executed. Specific examples of this output data include a binary matrix indicating that a specific staff member is assigned to cash register work at 1:00 p.m. and an integer value indicating that 100 pieces of product A are ordered. This formulation unit transfers an output result to a subsequent execution system and user interface unit. This execution system interprets the plan parameter matrix and directly executes automatic ordering and updating of a shift table on the system. With this configuration, this system derives an optimal solution satisfying a business constraint from an enormous number of combinations at high speed. This system automates plan formulation on a scale exceeding human calculation ability and dramatically improves business efficiency. This system simultaneously realizes minimization of opportunity loss and prevention of excess inventory. This technology is extremely useful in use cases such as food material ordering optimization for a restaurant chain expanding to multiple stores and staff allocation optimization for an apparel store.

The user interface unit collectively displays a trend analysis result, visualization information, an operation plan proposal, and the like transmitted from the server on a dashboard screen on the terminal, collectively displays a sales volume transition graph, a service use transition graph, an analysis comment in natural language by generative AI, a list of operation plan proposals, a priority and an implementation schedule of a measure, a simulation result of an expected effect, and the like, transmits a request to the server with a user designating conditions such as an analysis target period, a target region, a target product, a sales channel, and a type of measure, executes trend analysis and plan formulation again on the server side, returns the result to the terminal in real time, reflects it in analysis and plan formulation from the next time onward by the user selecting a measure desired to be implemented from the operation plan proposals and transmitting feedback to the server, realizes effect verification of the measure and automation of a PDCA cycle on the server side by the user inputting performance data after implementation of the measure from the terminal, automatically monitors sales, the number of visitors, customer satisfaction, a staff operation status, and the like after implementation of the measure, automatically extracts a measure having a high effect, and reflects it in plan formulation from the next time onward. Specifically, the user interface unit includes a front-end module constructed as a single-page application. The user interface unit receives a plan parameter matrix and a visualization data set transmitted from the server as input data. The input data includes a JSON object for graph drawing and character string data for text rendering. The number of dimensions of the input data is a hierarchical data structure depending on the number of components arranged on the screen. Specific examples of the input data include a floating-point array indicating a ratio of each segment of a pie chart and a list of title character strings of measures. The user interface unit efficiently updates an internal state of the application using a state management library. The user interface unit processes a user input operation as an asynchronous event. The user interface unit generates a user action log and a recalculation request vector as output data. A format of the output data is a structured payload including a time stamp, an operation type, and an input value. The output value includes an identifier of a filtering condition selected by the user and an evaluation score for the measure. Specific examples of the output data include a parameter array indicating that a target period is set to the past one week and a Boolean value indicating that a specific measure is approved. The user interface unit transmits an output result to the server in real time using WebSocket communication. The server transfers the received action log to a log analysis platform and uses it as a retraining trigger for a model. With this configuration, the system realizes a high-speed response that does not hinder user's thinking. The system accumulates a user operation history as learning data and continuously improves proposal accuracy of the system. The system provides a complex data analysis result in an intuitively operable form and accelerates decision-making in the field. The present technology is extremely useful in use cases such as a daily operation management tool for a store manager and a strategy formulation dashboard for headquarters staff.

A database management unit is responsible for accumulation, management, search, backup, restoration, access authority management, and the like of various data, centrally manages sales performance data, service use data, a measure implementation history, a user operation history, an external data cooperation history, and the like, operates a combination of a plurality of types such as a relational type, a NoSQL type, and a time-series database type according to an application, also implements maintenance of data consistency, high-speed search, data encryption, recording of an access log, and the like, and can search and extract data from various viewpoints such as by store, by product, by period, by customer attribute, and by measure. Specifically, the database management unit includes a data platform adopting a polyglot persistence architecture. The management unit receives a query character string issued from each module and a data object for writing as input data. The input data includes a command of a structured query language and a document in a JSON format. The number of dimensions of the input data depends on the number of columns of a target table and a nesting depth of the document. Specific examples of the input data include a query character string including a GROUP BY clause for aggregating sales data for a specific period and a set of key-value pairs including a new user operation log. The management unit converts the input character string into an abstract syntax tree using a query parser. The management unit determines an optimal data access path using a cost-based optimizer. The management unit applies a dedicated compression algorithm to time-series data to reduce a storage capacity. The management unit generates an execution result set of the query as output data. A format of the output data is two-dimensional tabular data consisting of rows and columns or a status code indicating completion of processing. The output value includes a value of each field of a record matching a search condition. Specific examples of the output data include an array of numerical values indicating a total monthly sales for each store and a boolean value indicating that data insertion is successful. The management unit returns an output result to a requesting module via a network protocol. The requesting module caches the received result set on a memory and uses it for subsequent processing. With this configuration, the system selects an optimal storage engine according to characteristics of data and maximizes input/output performance. The system guarantees a search response time on the order of milliseconds even for petabyte-scale data. The system provides highly available data access while maintaining data integrity and confidentiality. The present technology is extremely useful in use cases such as construction of a data lake that integrally manages transaction data of all stores and a real-time inventory allocation system.

An external cooperation unit is responsible for data cooperation with an external system and an external service, connects with diverse external systems such as an API of a market research company, acquisition of public information of a competitor, inventory cooperation with a logistics system, cooperation with an advertisement distribution system, data cooperation with an external BI tool, a weather information API, a traffic information API, and an event information API by an API, batch cooperation, file cooperation, or the like, also implements data conversion and format conversion at the time of external cooperation, authentication/authorization processing, error detection and retry processing, and the like, acquires external weather information to reflect it in demand forecasting for the number of visitors, cooperates with the logistics system to automate an inventory replenishment plan, and cooperates with the advertisement distribution system to automatically distribute a targeted advertisement. Specifically, the external cooperation unit includes a message broker based on an event-driven architecture. The cooperation unit receives an external cooperation request from inside the system or a webhook event from the external system as input data. The input data includes an identifier of a cooperation destination, an authentication token, and payload data to be transmitted. The number of dimensions of the input data is a variable-length structure depending on an endpoint specification of an API to be cooperated with. Specific examples of the input data include a list of identifiers and quantities of ordered products to be transmitted to the logistics system and a JSON array of weather forecast data for one week received from the weather information API. The cooperation unit executes protocol conversion processing on the input data. The cooperation unit implements a circuit breaker pattern to prevent a failure of the external system from spreading to the internal system. The cooperation unit automatically performs conversion between an external schema and an internal schema using a data mapping engine. The cooperation unit generates a cooperation completion status and a converted internal data tensor as output data. A format of the output data is an HTTP status code and structured tensor data. The output value includes a numerical value indicating success or failure of communication and a numerical value obtained by normalizing information acquired from the outside. Specific examples of the output data include a status code of 200 indicating communication success and a floating-point array in which acquired temperature data is unified into Celsius. The cooperation unit publishes an output result to a subsequent message queue. An internal module subscribing to the message queue receives the data and activates pipeline processing of the next stage. With this configuration, the system safely cooperates with diverse external services in a loosely coupled state. The system minimizes a delay from acquisition of external data to reflection in an internal model. The system captures a dynamic change in an external environment in real time and improves forecasting accuracy. The present technology is extremely useful in use cases such as automatic ordering cooperation with a supply chain management system and dynamic content distribution to digital signage.

A security management unit is responsible for security of the entire system, implements multi-layered security measures such as user authentication/authorization, communication encryption, unauthorized access detection, data falsification detection, access authority management, audit log recording, malware countermeasures, vulnerability diagnosis, and data masking, divides access authority between a store manager and staff, restricts access to important data and functions, encrypts a communication path to prevent eavesdropping and falsification from the outside, and periodically diagnoses vulnerability of the entire system to apply the latest security patch, thereby responding to advanced security requirements required for physical store operation. Specifically, the security management unit includes a machine learning-based threat intelligence engine. The management unit receives a user authentication request and mirror data of all network traffic in the system as input data. The input data includes user credential information, a transmission source IP address, and a header and a payload of a packet. The number of dimensions of the input data is a continuous byte stream depending on a bandwidth of a network. Specific examples of the input data include a hashed password character string and a group of packets of continuous connection requests to a specific port. The management unit executes deep packet inspection on the input data. The management unit detects a zero-day attack that does not depend on a known signature by an anomaly detection algorithm using a support vector machine. The management unit executes a hybrid encryption protocol combining a public key cryptosystem and a common key cryptosystem. The management unit generates an access permission/rejection token and a security alert vector as output data. A format of the output data is an encrypted session token or a numerical vector indicating a threat level. The output value includes a flag indicating success of authentication and a score indicating a probability that specific communication is an attack. Specific examples of the output data include a character string of a JSON Web Token valid for 24 hours and numerical data indicating that a probability of an SQL injection attack is 99 percent. The management unit transfers an output result to a subsequent firewall module and an audit log database. The firewall module automatically blocks communication from a malicious IP address based on the alert vector. With this configuration, the system completely protects customer data and management indicators from increasingly sophisticated cyber attacks. The system realizes strict access control without impairing convenience of a legitimate user. The system enables early discovery and automatic handling of a security incident. The present technology is extremely useful in use cases such as a settlement system handling credit card information and a customer relationship management system managing personal information.

Specific examples of a prompt sentence to be read by generative AI when implementing the present invention include “Based on data such as the number of sales of product A and product B, the number of point card acquisitions, the number of gift wrapping uses, the number of visitors, weather information, neighborhood event information, a staff shift, a customer attribute, a campaign history, and an inventory status in a physical store for the past 30 days, perform an increase/decrease trend of each indicator, a factor analysis, and demand forecasting for the next day, automatically generate a plurality of specific operation plan proposals such as inventory replenishment, a staff shift, a promotional event, a cross-selling measure, a layout change, targeted advertisement distribution, a staff education plan, and a measure by customer attribute, and present a priority and an expected effect together.” Specifically, the system includes a large language model specialized for natural language processing as a prompt processing engine. The prompt processing engine tokenizes input text data. The prompt processing engine converts the tokenized data into a high-dimensional embedding vector. The system processes the embedding vector using a transformer architecture having a self-attention mechanism. The system receives, as input data, structured data such as an array of the number of sales of product A for the past 30 days, a categorical variable vector of weather information, and a time-series matrix of a staff shift converted into natural language text, for example. The system inputs these input data as a 512-dimensional tensor to the large language model. The system outputs a score value from 0.0 to 1.0 indicating a priority of each measure as an output of the large language model. The system outputs numerical data of a sales increase predicted value indicating an expected effect. The system outputs a sequence of natural language text constituting a specific operation plan proposal. The system extracts only a measure whose output score value exceeds a predetermined threshold. The system transmits the extracted measure to a subsequent plan formulation module. The system executes feature amount extraction in a high-dimensional space that does not depend on human intuition. Thereby, the system accurately specifies a hidden correlation of complexly intertwined store operation factors. As a result, the system significantly improves accuracy of demand forecasting compared to a conventional method. The system is applied to resource optimization in physical store operation such as a retail business and a restaurant business.

### Implementation Steps

### Step 1: Multidimensional Automatic Collection of Physical Store Operation Data

A physical store operation data acquisition unit automatically collects data such as the number of sales for each product, sales by time zone, sales by settlement method, the number of returns/exchanges, the number of campaign applications, and the number of people passing through a cash register from a POS terminal, data such as the number of new acquisitions of point cards and membership services, a visit frequency of an existing member, customer attribute information, questionnaire answer contents, and a customer satisfaction score from a customer management system, data such as the number of gift wrapping uses, the number of extended warranty applications, consumption of wrapping materials, and a use status of a service counter from a service management system, data such as the number of visitors, a visitor attribute, a stay time, and a peak time zone from an entry/exit sensor, a face recognition camera, the number of uses of a POS cash register, the number of Wi-Fi connected terminals, beacon detection of a smartphone, and the like, data such as a staff allocation status, a work record, a sales performance for each staff member, a customer service evaluation, a break acquisition status, and overtime hours from a staff shift management system, data such as an implementation history of a promotional event and a campaign, the number of event participants, sales by event, a customer attribute by event, and an event questionnaire result from an event management system, data such as weather information, neighborhood event information, and traffic information from an external API, data such as an inventory status for each product, a replenishment history, the number of remaining orders, expiration date management, an inventory result, and a disposal history from an inventory management system, and data such as an operation status of refrigeration/freezing equipment, an operation status of lighting/air conditioning, an equipment failure history, and energy consumption from a store equipment management system at diverse granularities such as daily, weekly, monthly, quarterly, and yearly, performs data normalization and cleansing processing, automatic detection of an abnormal value and a missing value, and complementation/exclusion processing, and enables data acquisition and accumulation from diverse viewpoints such as by sales channel, by region, by product category, and by period, and grasping of a trend of an entire chain by data integration of a plurality of stores. Specifically, the physical store operation data acquisition unit includes a plurality of asynchronous communication interfaces. The physical store operation data acquisition unit receives heterogeneous mixed data transmitted from each system in real time. The physical store operation data acquisition unit temporarily stores the received data in an in-memory database. The physical store operation data acquisition unit executes cleansing by parallel processing on the stored data. The physical store operation data acquisition unit applies an automatic complementation algorithm using a K-nearest neighbor method to a missing value. The physical store operation data acquisition unit performs outlier detection on an abnormal value using an isolation forest algorithm. The physical store operation data acquisition unit excludes or smooths the detected outlier based on statistical significance. The physical store operation data acquisition unit converts the normalized data into a multidimensional tensor format. The physical store operation data acquisition unit generates, for example, a fourth-order tensor having a store ID, a time axis, a product category, and a customer attribute as axes. The physical store operation data acquisition unit adapts this tensor data to an input format of a subsequent machine learning model. The physical store operation data acquisition unit adopts multi-thread processing in a data collection process. Thereby, the physical store operation data acquisition unit eliminates a processing bottleneck due to a network delay or data loss. The physical store operation data acquisition unit eliminates data aggregation by human manual work. The physical store operation data acquisition unit dramatically improves data processing throughput of the entire computer system. The physical store operation data acquisition unit is applied to construction of an integrated data warehouse in a large-scale chain store.

### Step 2: Multifaceted Trend Analysis and Visualization by Generative AI

A generative AI trend analysis unit implements, with the collected diverse data as an input, time-series analysis of a sales transition for each product, a service use transition, and a visitor number transition, an increase/decrease trend, a seasonal variation, periodicity, a sudden fluctuation, detection of an abnormal value, a trend comparison by sales channel, by region, and by product category, an increase/decrease factor of sales and service use, a correlation analysis among a plurality of indicators, a trend analysis of a specific time zone and a specific customer segment, trend extraction of a sales performance and a customer service evaluation for each staff member, and the like using generative AI, automatically extracts strengths and weaknesses in natural language, automatically generates a transition of a sales volume as a bar graph or a line graph, a transition of an option acquisition rate as a heat map, a correlation between the sales volume and the number of optional service acquisitions as a scatter plot, and a comparison by channel, by region, and by product category as a radar chart or a stacked graph, and outputs visualization information in a form that a user can intuitively understand. Specific examples of a prompt sentence to be read by generative AI include “Based on data such as the number of sales of product A and product B, the number of point card acquisitions, the number of gift wrapping uses, the number of visitors, weather information, neighborhood event information, a staff shift, a customer attribute, a campaign history, and an inventory status in a physical store for the past 30 days, perform an increase/decrease trend of each indicator, a factor analysis, and demand forecasting for the next day, automatically generate a plurality of specific operation plan proposals such as inventory replenishment, a staff shift, a promotional event, a cross-selling measure, a layout change, targeted advertisement distribution, a staff education plan, and a measure by customer attribute, and present a priority and an expected effect together.” Specifically, the generative AI trend analysis unit adopts a hybrid architecture integrating a recurrent neural network specialized for time-series data analysis and a large language model. The generative AI trend analysis unit receives one-dimensional array data indicating the number of sales for the past 30 days as input data. The generative AI trend analysis unit receives a one-hot encoding vector of a categorical variable indicating weather information. The generative AI trend analysis unit receives a time-series tensor indicating the number of visitors. The generative AI trend analysis unit combines these input data to generate a multidimensional feature amount vector. The generative AI trend analysis unit inputs this feature amount vector to a hidden layer of the recurrent neural network. The generative AI trend analysis unit outputs a context vector from which a time-series dependency relationship is extracted. The generative AI trend analysis unit maps this context vector to a prompt space of the large language model. The generative AI trend analysis unit generates a sequence of natural language text explaining an increase/decrease factor as an output from the large language model. The generative AI trend analysis unit outputs a matrix of floating-point numbers indicating a correlation coefficient of each indicator. The generative AI trend analysis unit outputs a drawing parameter group for visualization. The generative AI trend analysis unit transmits this drawing parameter group to a subsequent rendering engine. The generative AI trend analysis unit drives the rendering engine to dynamically generate various graph images. The generative AI trend analysis unit calculates a non-linear correlation in a high-dimensional space. The generative AI trend analysis unit enables discovery of a complex data pattern exceeding human cognitive limits. Thereby, the generative AI trend analysis unit significantly shortens a calculation time required for data analysis. The generative AI trend analysis unit is applied to a support system for formulation of a marketing strategy and optimization of store operation.

### Step 3: Factor Analysis and Hypothesis Generation by Generative AI

The generative AI trend analysis unit explains a fluctuation factor and a background of the number of sales, the number of service uses, the number of visitors, and the like based on a trend analysis result and visualization information in natural language by combining a plurality of factors such as “an increase in sales of product A is an effect of a new promotional campaign”, “an increase in use of gift wrapping is linked to an event period such as Mother's Day or Christmas”, “a decrease in the number of visitors is an influence of bad weather or a neighborhood event”, “sales in a time zone in charge of a specific staff member are high”, and “a visit frequency of a specific customer segment is increasing” while referring to past data and external information, and generates a hypothesis about a fluctuation factor of a sales transition and a service use transition. Specific examples of a prompt sentence to be read by generative AI include “Based on physical store data for the past 30 days, present a hypothesis about a fluctuation factor and a background of each indicator in natural language while also referring to external information.” Specifically, the generative AI trend analysis unit includes a transformer-based neural network incorporating a causal inference algorithm. The generative AI trend analysis unit receives a feature amount vector indicating a trend analysis result as input data. The generative AI trend analysis unit receives a text embedding vector of a news article and event information acquired as external information. The generative AI trend analysis unit inputs these vectors to a self-attention mechanism. The generative AI trend analysis unit calculates an attention weight among respective factors. The generative AI trend analysis unit extracts a factor pair whose attention weight exceeds a predetermined threshold. The generative AI trend analysis unit generates a graph structure of a causal relationship based on the extracted factor pair. The generative AI trend analysis unit inputs this graph structure to a large language model. The generative AI trend analysis unit outputs text data in natural language constituting a hypothesis as an output from the large language model. The generative AI trend analysis unit outputs a reliability score indicating likelihood of each hypothesis. The generative AI trend analysis unit outputs a reliability score of 0.85 together with text of a sales increase due to a campaign effect, for example. The generative AI trend analysis unit uses this reliability score as a weighting parameter in a subsequent plan formulation module. The generative AI trend analysis unit is pre-trained to minimize a difference between a past hypothesis and performance data using a cross-entropy error function. The generative AI trend analysis unit eliminates human subjective guessing. The generative AI trend analysis unit realizes data-driven objective hypothesis generation on a computer. Thereby, the generative AI trend analysis unit brings about speeding up and accuracy improvement of a hypothesis verification cycle. The generative AI trend analysis unit is applied to factor specification of demand fluctuation and a risk management system in a retail business.

### Step 4: Demand Forecasting and Automatic Generation of Operation Plan Proposal by Generative AI

An operation plan formulation unit performs demand forecasting for the number of sales of each product, the number of service uses, the number of visitors, and the like for the next day or the next week and thereafter using generative AI based on an analysis result and visualization information of the trend analysis unit, automatically generates a plurality of diverse and specific operation plan proposals related to physical store operation, such as inventory replenishment, staff shift optimization, promotional event implementation, a cross-selling measure, a layout change, targeted advertisement distribution, a staff education plan, a measure by customer attribute, prioritization of measures and a proposal of an implementation timing, a simulation of an expected effect, a necessary resource and a cost estimate, extraction of a risk factor, and an effect verification plan after measure implementation according to a forecasting result, and presents the plurality of diverse and specific operation plan proposals to a store manager or a staff terminal in an easy-to-understand manner. Specific examples of a prompt sentence to be read by generative AI include “Based on physical store data for the latest 30 days, predict the number of sales, the number of service uses, the number of visitors, and the like for the next day and the next week, automatically generate a plurality of specific operation plan proposals such as inventory replenishment, a staff shift, a promotional event, a cross-selling measure, a layout change, targeted advertisement distribution, a staff education plan, and a measure by customer attribute based on a prediction result, and present a priority and an expected effect together.” Specifically, the operation plan formulation unit includes a hybrid inference engine linking a deep reinforcement learning model and a large language model. The operation plan formulation unit receives a time-series tensor indicating a past sales performance as input data. The operation plan formulation unit receives an embedding vector of a hypothesis output from the generative AI trend analysis unit. The operation plan formulation unit maps these input data to a state space of the deep reinforcement learning model. The operation plan formulation unit calculates a future demand predicted value using the deep reinforcement learning model. The operation plan formulation unit outputs an integer value of 150 as a predicted number of sales of product A for the next day, for example. The operation plan formulation unit outputs an integer value of 3200 as a predicted number of visitors for the next week. The operation plan formulation unit dynamically embeds this predicted numerical value into a prompt of the large language model. The operation plan formulation unit outputs structured JSON data indicating a specific operation plan proposal as an output from the large language model. The operation plan formulation unit includes key-value pairs such as a name of a measure, a priority score, an estimated value of a necessary cost, and an expected sales increase rate in this JSON data. The operation plan formulation unit transmits this structured data to a subsequent user interface unit. The operation plan formulation unit defines profit maximization and cost minimization of a store as a reward function in deep reinforcement learning. The operation plan formulation unit optimizes a weight of a model by a policy gradient method based on this reward function. The operation plan formulation unit executes a mathematical optimization calculation that does not depend on a human rule of thumb. Thereby, the operation plan formulation unit makes calculation resources required for plan formulation efficient. At the same time, the operation plan formulation unit dramatically enhances feasibility and return on investment of a plan. The operation plan formulation unit is applied to an integrated management system of a franchise chain developing multiple stores.

Step 5: Information presentation and interaction by a user interface The user interface unit collectively displays a trend analysis result, visualization information, an operation plan proposal, and the like transmitted from the server on a dashboard screen on the terminal, collectively displays a sales volume transition graph, a service use transition graph, an analysis comment in natural language by generative AI, a list of operation plan proposals, a priority and an implementation schedule of a measure, a simulation result of an expected effect, and the like, the user specifies conditions such as an analysis target period, a target region, a target product, a sales channel, and a type of measure and transmits a request to the server, the server side executes trend analysis and plan formulation again, returns the result to the terminal in real time, the user selects a measure desired to be implemented from the operation plan proposals and transmits feedback to the server to reflect it in the analysis and plan formulation from the next time onward, the user inputs performance data after implementation of the measure from the terminal to realize effect verification of the measure and automation of a PDCA cycle on the server side, and sales, the number of visitors, customer satisfaction, a staff operation status, and the like after implementation of the measure are automatically monitored to automatically extract a highly effective measure and reflect it in the plan formulation from the next time onward. Specifically, the user interface unit establishes a constant connection with the server using an asynchronous communication protocol. The user interface unit receives structured JSON data transmitted from the server. The user interface unit caches the received data in a memory on a client side. The user interface unit generates a dynamic HTML element based on the cached data. The user interface unit renders various graphs and texts on the dashboard screen. The user interface unit receives a condition specification input from the user. The user interface unit parameterizes the input condition and transmits it to the server as an API request. The user interface unit receives a recalculation result from the server with a delay in milliseconds. The user interface unit partially redraws only a corresponding part of the screen. The user interface unit transmits an ID of the measure selected by the user and a feedback evaluation value to the server. The server uses this feedback evaluation value as a reward signal of a reinforcement learning model. The server sequentially updates a weight parameter of the model by online learning. The system accumulates the performance data after implementation of the measure in a time-series database. The system compares the performance data and prediction data to calculate an error tensor. The system automatically triggers retraining of a prediction model using this error tensor. The system utilizes the operation input of the user not merely as a screen transition but as training data for continuous improvement of an AI model. Thereby, the system autonomously improves inference accuracy of the entire system over time. The system achieves both reduction of a data communication amount and speeding up of screen drawing. The system is applied to a decision-making support platform for management and on-site managers.

### Specific Use Case

For example, when the system of the present invention is applied in a physical store, data such as the number of sales of a product A and a product B, sales by time zone, sales by settlement method, the number of returns/exchanges, the number of campaign applications, and the number of people passing through a cash register are automatically collected daily from a POS terminal, data such as the number of new acquisitions of point cards, a visit frequency of existing members, customer attribute information, questionnaire answer contents, and a customer satisfaction score are acquired from a customer management system, data such as the number of gift wrapping uses, the number of extended warranty applications, a wrapping material consumption amount, and a service counter use status are acquired from a service management system, the number of visitors, visitor attributes, a stay time, a peak time zone, and the like are acquired from an entry/exit sensor, a face recognition camera, the number of POS cash register uses, the number of Wi-Fi connected terminals, beacon detection of a smartphone, and the like, a staff allocation status, a work record, a sales performance for each staff member, a customer service evaluation, a break acquisition status, an overtime hour, and the like are acquired from a staff shift management system, a promotional event implementation history, the number of event participants, sales by event, customer attributes by event, an event questionnaire result, and the like are acquired from an event management system, weather information, neighborhood event information, traffic information, and the like are acquired from an external API, an inventory status for each product, a replenishment history, the number of remaining orders, expiration date management, an inventory result, a disposal history, and the like are acquired from an inventory management system, a refrigeration/freezing equipment operation status, a lighting/air conditioning operation status, an equipment failure history, an energy consumption amount, and the like are acquired from a store equipment management system, these data are automatically collected at diverse granularities such as daily, weekly, and monthly, data normalization and cleansing processing, and automatic detection and complementation/exclusion processing of an abnormal value and a missing value are performed, and data acquisition and accumulation from diverse viewpoints such as by sales channel, by region, by product category, and by period, and trend grasping of the entire chain by data integration of a plurality of stores are also enabled. Specifically, the system is constructed based on a distributed data streaming platform. The system allocates a lightweight data collection agent to an IoT device and a business system of each store. The data collection agent immediately transmits generated event data to a message queue. The system asynchronously reads data from the message queue. The system executes real-time conversion processing on the read data using a stream processing engine. The system receives, for example, an image tensor obtained from the face recognition camera as an input. The system extracts a feature vector indicating an age group and a gender of a customer from the image tensor using a convolutional neural network. The system stores the extracted feature vector in a database after anonymization processing. The system parses transaction data from the POS terminal. The system converts the transaction data into a structured record consisting of a product ID, a time stamp, and a purchase amount. The system maps these heterogeneous data onto a common timeline. The system dynamically constructs a multidimensional data cube. The system executes OLAP processing on the data cube in-memory. Thereby, the system shortens a response time of an aggregation query for petabyte-class large-scale data to the order of milliseconds. The system enables complex cross analysis that has been difficult with a conventional relational database. The system maximizes utilization efficiency of hardware resources. The system is applied to advanced behavior analysis and operation optimization in a smart store and an unmanned store.

The generative AI trend analysis unit extracts trends such as, for example, the number of sales of the product A transitioning upward in the latest 30 days, the number of sales of the product B being in a decreasing trend, the number of point card acquisitions being stable, the number of gift wrapping uses rapidly increasing on a specific weekend or holiday, the number of visitors being small overall, the number of visitors concentrating in a specific time zone, sales being high in a time zone in charge of a specific staff member, and a visit frequency of a specific customer segment increasing, explains an increase/decrease factor of sales and service use in natural language by combining a plurality of factors such as “an increase in sales of the product A is an effect of a new promotional campaign”, “an increase in use of gift wrapping is linked to an event period such as Mother's Day or Christmas”, “a decrease in the number of visitors is an influence of bad weather or a neighborhood event”, “sales are high in a time zone in charge of a specific staff member”, and “a visit frequency of a specific customer segment is increasing”, automatically generates a transition of a sales volume with a bar graph or a line graph, a transition of an option acquisition rate with a heat map, a correlation between the sales volume and the number of optional service acquisitions with a scatter plot, and a comparison by channel, by region, and by product category with a radar chart or a stacked graph, and outputs visualization information in a form that the user can intuitively understand. Furthermore, it automatically extracts strengths and weaknesses in natural language and outputs them in a form that an on-site person in charge or a manager can immediately understand, such as “it is a strength that the number of sales of the product A is stably increasing”, “it is a problem that the number of gift wrapping uses is in a decreasing trend”, “a staff shortage occurs in a specific time zone”, and “reach to a specific customer segment is weak”. Specifically, the generative AI trend analysis unit implements a deep learning model having a multimodal data processing capability. The generative AI trend analysis unit receives a time-series numerical matrix as input data. The generative AI trend analysis unit receives campaign history data in a text format. The generative AI trend analysis unit projects these data of different modalities onto a common latent space vector. The generative AI trend analysis unit applies a clustering algorithm to this latent space vector. The generative AI trend analysis unit automatically groups an indicator group having a similar fluctuation pattern. The generative AI trend analysis unit extracts a main fluctuation factor from the grouped data using principal component analysis. The generative AI trend analysis unit inputs the extracted factor vector to a decoder of a large language model. The generative AI trend analysis unit generates a sentence in natural language explaining a trend as an output from the large language model. The generative AI trend analysis unit outputs a text that, for example, an increase in sales of the product A is an effect of a new promotional campaign. The generative AI trend analysis unit outputs numerical data from 0.0 to 1.0 indicating a contribution degree of the factor together with this text. The generative AI trend analysis unit outputs a drawing command in a JSON format including a drawing type, a scale of an axis, and a coordinate array of data points to a visualization module. The generative AI trend analysis unit causes a dynamic graph to be rendered on a front end using this drawing command. The generative AI trend analysis unit algorithmizes a complex data interpretation process performed by a human analyst. Thereby, the generative AI trend analysis unit dramatically shortens a creation time of an analysis report. The generative AI trend analysis unit eliminates a personalized analysis bias and realizes objective and highly accurate insight extraction. The generative AI trend analysis unit is applied to strategy formulation support in a marketing department and a store development department of a retail business.

The operation plan formulation unit performs demand forecasting for the number of sales of each product, the number of service uses, the number of visitors, and the like for the next day or the next week and thereafter using generative AI based on an analysis result and visualization information of the trend analysis unit, automatically generates a plurality of diverse and specific operation plan proposals related to physical store operation, such as inventory replenishment, staff shift optimization, promotional event implementation, a cross-selling measure, a layout change, targeted advertisement distribution, a staff education plan, a measure by customer attribute, prioritization of measures and a proposal of an implementation timing, a simulation of an expected effect, a necessary resource and a cost estimate, extraction of a risk factor, and an effect verification plan after measure implementation according to a forecasting result, outputs a specific numerical prediction such as, for example, “the number of sales of the product A for the next day is expected to increase by 10% from today”, “the number of point card acquisitions is maintained as it is”, “the number of visitors is highly likely to decrease due to an influence of weather deterioration”, and “an increase in staff is necessary because the number of visitors concentrates in a specific time zone”, presents a plurality of specific measure proposals such as “it is recommended to replenish the inventory of the product A more than usual when an increase in sales of the product A is predicted”, “it is recommended to implement a point card enrollment promotion campaign when the number of point card acquisitions is sluggish”, “it is recommended to implement a customer attraction event or a time sale when the number of visitors is in a decreasing trend”, “it is recommended to increase staff in charge of gift wrapping or additionally order wrapping materials when an increase in use of gift wrapping is predicted”, “adjust a staff shift in a specific time zone to optimize personnel allocation at a peak time”, “distribute a targeted advertisement to a specific customer segment”, “change a layout in accordance with a release of a new product”, and “formulate a staff education plan to aim at strengthening of a cross-selling measure”, cooperates with a staff shift management system to automatically optimize a staff allocation plan according to the predicted number of visitors and number of sales, learns a past measure implementation history and its effect data to enable utilization of experiential knowledge such as “it is recommended to implement a similar measure again because a specific promotion among campaigns implemented in the past contributed most to an improvement in an option acquisition rate” and “plan a new event with reference to a day of the week and a time zone in which a customer attraction effect was high in a past event”, and automatically generates a priority and an implementation timing of a measure, an expected effect, a necessary resource, a cost estimate, a risk factor, an effect verification plan after measure implementation, and the like to present them to a store manager or a staff terminal in an easy-to-understand manner. Specifically, the operation plan formulation unit executes an inference pipeline integrating predictive modeling and a combinatorial optimization algorithm. The operation plan formulation unit receives a multivariate time-series tensor including a past sales performance and the number of visitors as input data. The operation plan formulation unit inputs this tensor to a long short-term memory network. The operation plan formulation unit generates a numerical vector including a predicted value of each indicator for the next day and thereafter as an output from the long short-term memory network. The operation plan formulation unit inputs this predicted value vector to a mixed integer linear programming solver as a constraint condition. The operation plan formulation unit calculates an optimal resource allocation matrix that maximizes a profit while satisfying constraints such as an upper limit of staff working hours and an inventory capacity. The operation plan formulation unit converts this resource allocation matrix into a prompt of a large language model. The operation plan formulation unit generates a text sequence in natural language including a specific action instruction as an output from the large language model. The operation plan formulation unit outputs a text to, for example, additionally order 50 pieces of inventory of the product A. The operation plan formulation unit outputs a floating-point number indicating an expected sales increase amount together with this text. The operation plan formulation unit analyzes past measure history data using a graph neural network. The operation plan formulation unit quantifies a synergistic effect and cannibalization among measures. The operation plan formulation unit calculates a priority score of a measure based on this quantified effect indicator. The operation plan formulation unit filters and outputs only a measure having a high priority score. The operation plan formulation unit mathematically derives an optimal plan from an enormous number of combination patterns. Thereby, the operation plan formulation unit instantaneously formulates a highly efficient store operation plan unreachable by human intuition. The operation plan formulation unit is applied to a core business system of a general supermarket or a department store having large-scale personnel and inventory.

As a specific example of a prompt sentence to be read by the generative AI, “based on data such as the number of sales of a product A and a product B, the number of point card acquisitions, the number of gift wrapping uses, the number of visitors, weather information, neighborhood event information, a staff shift, customer attributes, a campaign history, and an inventory status in a physical store for the past 30 days, perform an increase/decrease trend of each indicator, a factor analysis, and demand forecasting for the next day, automatically generate a plurality of specific operation plan proposals such as inventory replenishment, a staff shift, a promotional event, a cross-selling measure, a layout change, targeted advertisement distribution, a staff education plan, and a measure by customer attribute, and present a priority and an expected effect together” is cited. Specifically, the system includes a dynamic prompt generation module that automates prompt engineering. The dynamic prompt generation module converts the latest store operation data extracted from a database into a structured format. The dynamic prompt generation module inputs the converted data to a template engine. The dynamic prompt generation module embeds an actual numerical value and categorical data in a placeholder. Thereby, the dynamic prompt generation module dynamically synthesizes a prompt character string optimized for a context. The system transmits this synthesized prompt character string to an input interface of a large language model. The system receives a list of key-value pairs such as, for example, the number of sales of the product A being 300, the weather being rain, and the number of staff members being 5 as input data. The system outputs step-by-step text data indicating an execution procedure of each measure as an output from the large language model. The system outputs numerical data of a percentage indicating an expected effect of each measure. The system parses the output text data using a natural language processing technology. The system extracts an executable command group from a result of the parsing. The system transmits this command group to a subsequent automatic ordering system and shift management system via an API. The system completely automates from generation of a prompt to cooperation with a subsequent system. Thereby, the system eliminates an error of manual input by a human operator. The system minimizes a processing latency of the entire system and supports real-time decision-making. The system is applied to an agile store operation platform in a rapidly changing retail market.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

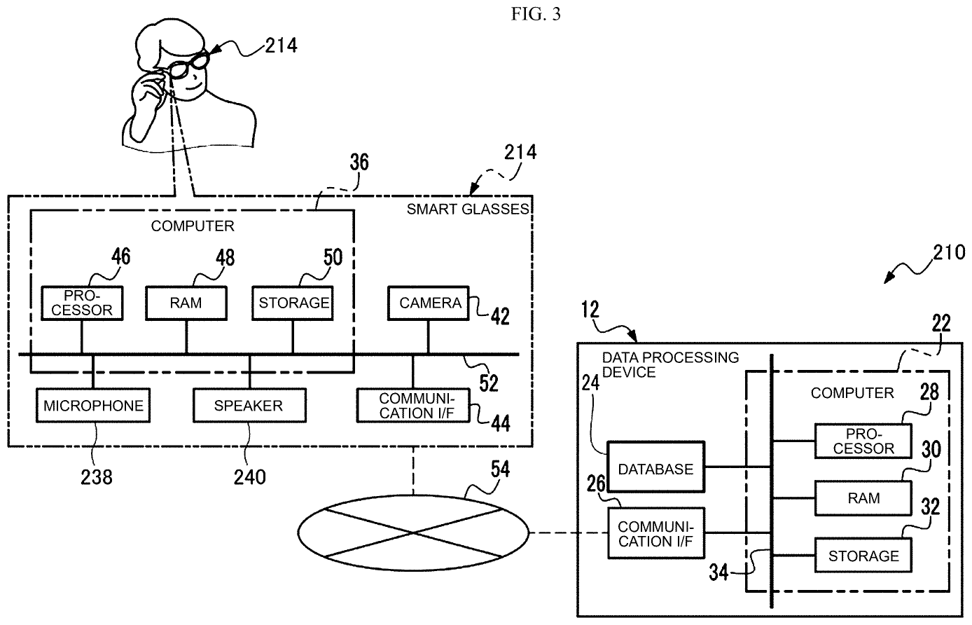

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

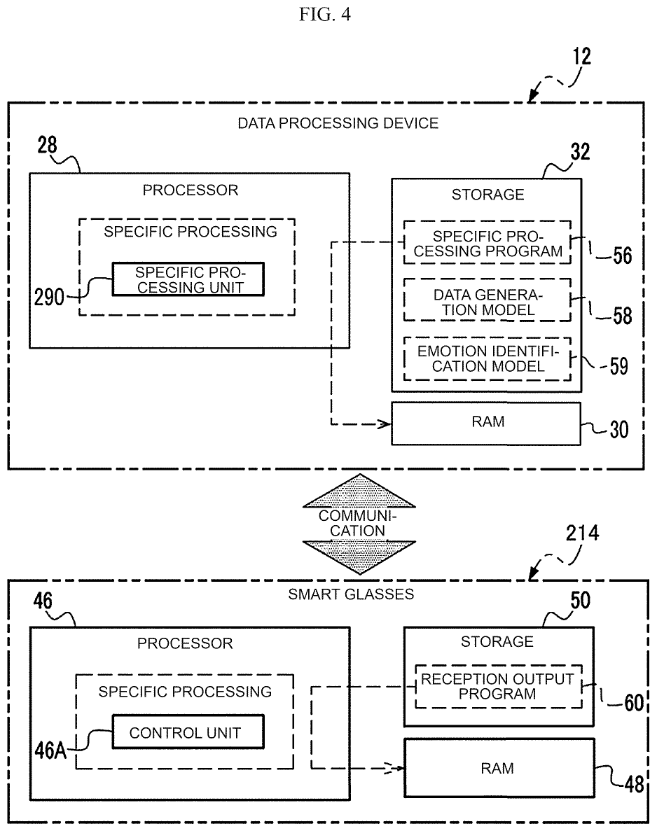

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

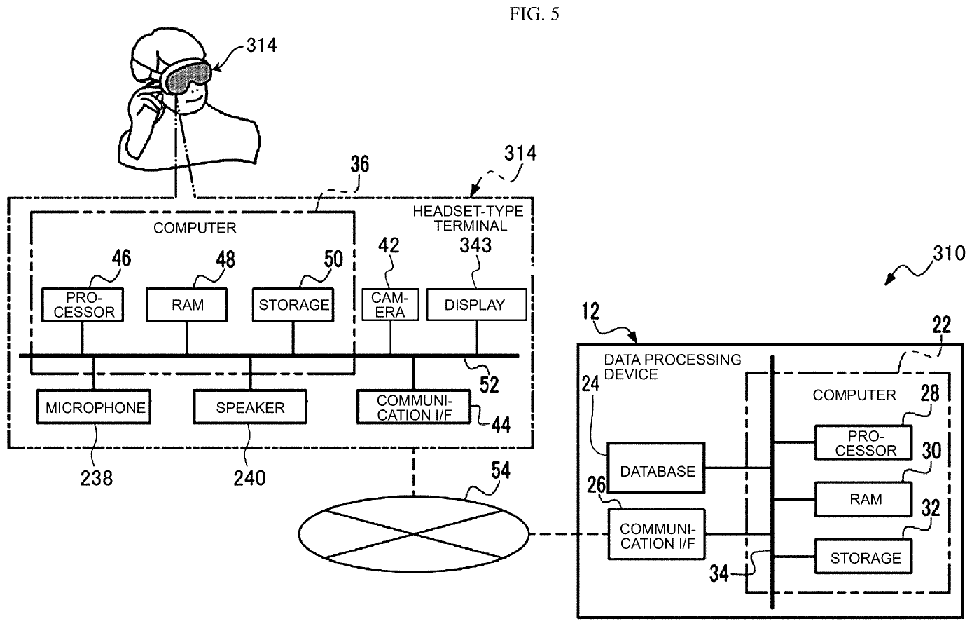

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

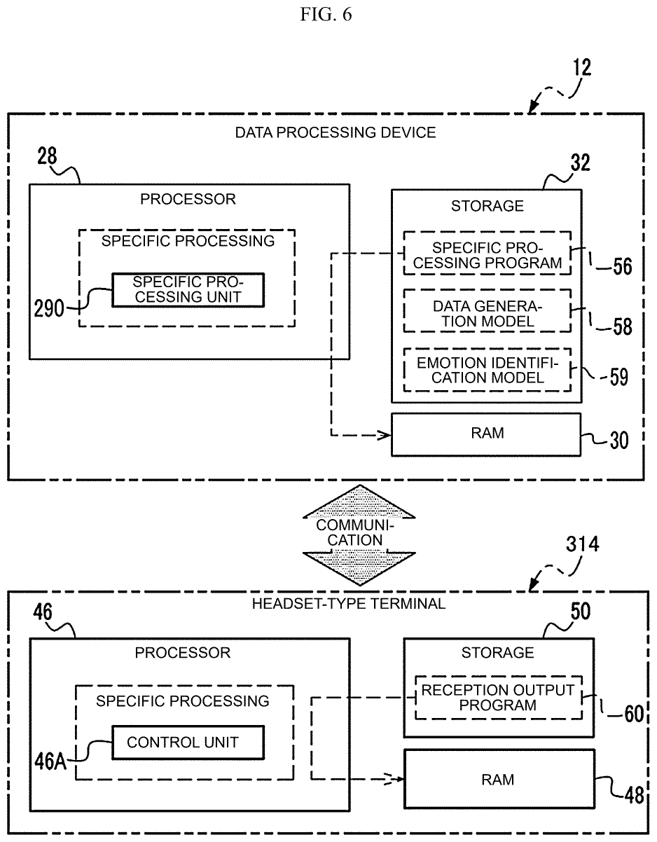

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

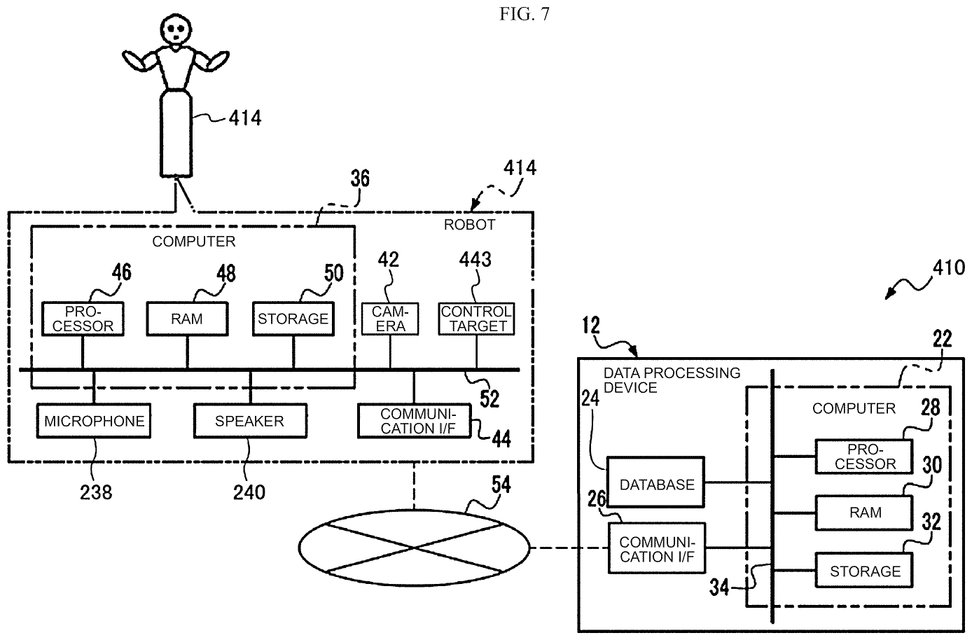

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

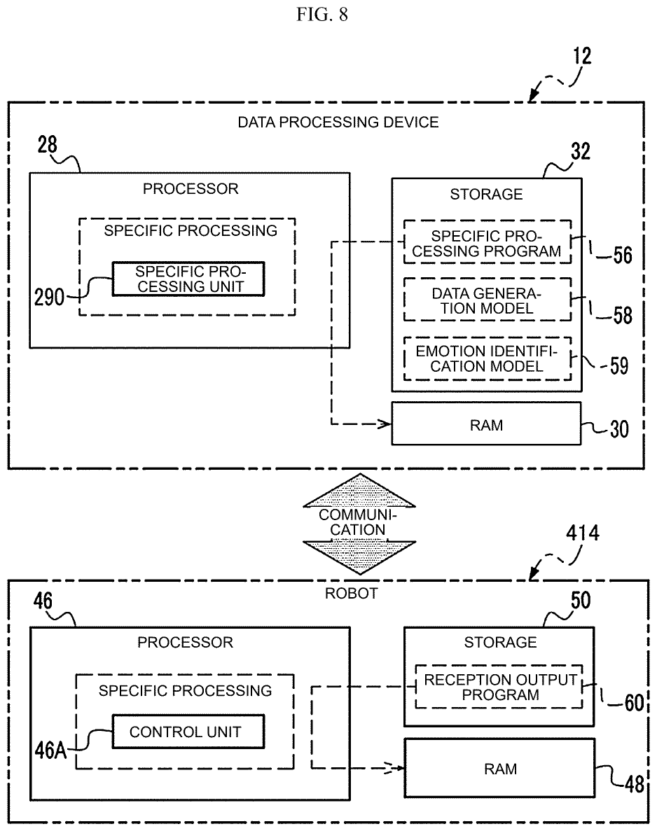

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

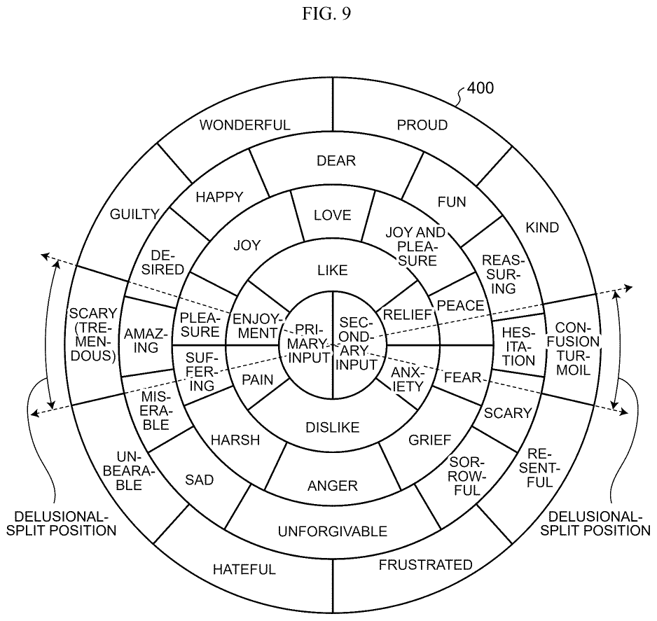

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

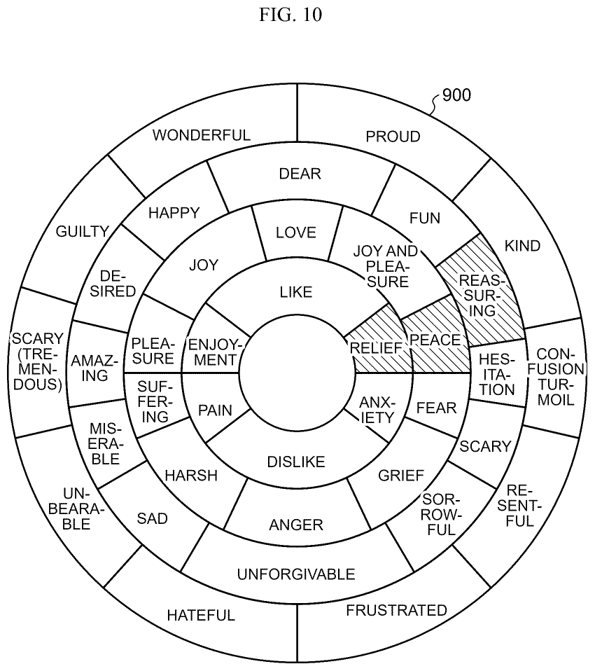

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a physical store operation data acquisition unit; a generative AI trend analysis unit; and an operation plan formulation unit, wherein the physical store operation data acquisition unit automatically collects diverse data such as the number of sales for each product in a physical store, the number of new acquisitions of point cards and membership services, the number of gift wrapping uses, the number of visitors, sales by time zone, a staff allocation status, a campaign implementation history, weather information, and neighborhood event information from a POS terminal, a customer management system, a shift management system, an event management system, an external API, or the like, and executes data normalization and cleansing processing; the generative AI trend analysis unit analyzes, from multiple viewpoints using generative AI, a sales transition for each product, a service use transition, a visitor number transition, an increase/decrease trend of various indicators, a seasonal variation, an abnormal value, a trend comparison by sales channel, by region, and by product category, an increase/decrease factor of sales and service use, a correlation analysis among a plurality of indicators, and the like, with the acquired diverse data as an input, automatically extracts strengths and weaknesses and a factor analysis result in natural language, and further automatically generates visualization information such as a graph and a table; and the operation plan formulation unit performs demand forecasting for the number of sales of each product, the number of service uses, the number of visitors, and the like for the next day or the next week and thereafter using generative AI based on an analysis result and the visualization information of the trend analysis unit, automatically generates a plurality of specific store operation plan proposals such as inventory replenishment, staff shift optimization, promotional event implementation, a cross-selling measure, a layout change, and targeted advertisement distribution according to a forecasting result, and presents a priority, an implementation timing, an expected effect, a necessary resource, a cost estimate, a risk factor, and the like together to a store manager or a staff terminal.

### Supplementary Note 2

The system according to Supplementary Note 1, wherein the generative AI trend analysis unit performs processing of, for diverse data such as the number of sales for each product, the number of service uses, the number of visitors, a staff allocation status, weather information, and neighborhood event information, analyzing an increase/decrease trend and a seasonal variation, detecting an abnormal value, comparing trends by channel, by region, and by product category, analyzing a correlation among a plurality of indicators, extracting an increase/decrease factor of sales and service use, and further visualizing a sales transition and a service use transition, automatically extracting strengths and weaknesses and a factor analysis result in natural language, generating a hypothesis, and the like using generative AI.

### Supplementary Note 3

The system according to Supplementary Note 1, wherein the operation plan formulation unit automatically generates, using generative AI, a plurality of diverse and specific operation plan proposals related to physical store operation, such as inventory replenishment, staff shift optimization, promotional event implementation, a cross-selling measure, a layout change, targeted advertisement distribution, a staff education plan, a measure by customer attribute, prioritization of measures and a proposal of an implementation timing, a simulation of an expected effect, a necessary resource and a cost estimate, extraction of a risk factor, and an effect verification plan after measure implementation, based on the analysis result of the trend analysis unit and a demand forecasting result, and presents the plurality of diverse and specific operation plan proposals to a store manager or a staff terminal.

What is claimed is:

1. A system comprising:
circuitry configured to:
receive, via a communication interface coupled to a packet-switched network, time-series operational metric data from a plurality of computing nodes, apply a moving average filter to the time-series operational metric data to remove noise, and store the filtered data in a storage device;
apply a machine learning model for resource allocation optimization to the filtered time-series operational metric data to compute a resource allocation adjustment vector, and transmit resource configuration commands to computing node control interfaces via the communication interface based on the resource allocation adjustment vector;
apply a generative neural network model to the filtered time-series operational metric data and historical metric records retrieved from a vector database to generate an operational state data record comprising metric deviation indicators, capacity utilization parameters, and a resource demand prediction vector;
generate a system control parameter record by applying the generative neural network model to the resource demand prediction vector and historical operational records to produce parameter adjustment sequences with associated predicted metric trajectories; and
transmit the operational state data record and the system control parameter record to terminal devices via the communication interface.

2. The system according to claim 1, wherein the circuitry is configured to receive numerical data comprising processing unit utilization rates, memory consumption values, network traffic volumes, and database query response times from computing node sensor interfaces via the communication interface at a predetermined collection interval, and apply the moving average filter to each metric dimension independently to extract smoothed trend components.

3. The system according to claim 2, wherein the circuitry is configured to apply a transformer-based time-series model to the smoothed trend components to generate multi-step ahead prediction values for each metric dimension, compute a prediction confidence interval by Monte Carlo dropout sampling, and incorporate the prediction values and confidence intervals as the resource demand prediction vector.

4. The system according to claim 3, wherein the circuitry is configured to detect a capacity constraint condition when a predicted metric value in the resource demand prediction vector exceeds a capacity threshold parameter, generate a scaling recommendation data record comprising a recommended resource allocation adjustment and a projected time-to-constraint value, and transmit the scaling recommendation data record to terminal devices associated with administrative user identifiers.

5. The system according to claim 1, wherein the circuitry is configured to apply an autoencoder anomaly detection model pre-trained on time-series operational metric data representing normal operating conditions to incoming metric data arrays, compute reconstruction error scores, and generate an anomaly alert data record comprising the affected computing node identifier and anomaly type when a reconstruction error score exceeds an anomaly threshold.

6. The system according to claim 5, wherein the circuitry is configured to apply the generative neural network model to the anomaly alert data record and historical anomaly records retrieved from the vector database by cosine similarity search to generate a root cause analysis text and a recommended remediation sequence, and incorporate both in the system control parameter record.

7. The system according to claim 1, wherein the circuitry is configured to apply a natural language processing model to unstructured log text data received from computing nodes to extract error code labels, warning category labels, and timestamp values, and incorporate the extracted labels as categorical feature dimensions alongside the numerical metric data in the filtered time-series operational metric data.

8. The system according to claim 1, wherein the circuitry is configured to deploy each functional processing unit as an independent containerized microservice, distribute incoming metric data across containerized microservices via a message queue using a publish-subscribe model, and scale each containerized microservice independently based on current processing load metrics.

9. The system according to claim 1, wherein the circuitry is configured to generate visualization output data from the operational state data record comprising time-series charts of metric trajectories, resource utilization heat maps, and predicted capacity projection curves, and transmit the visualization output data to terminal devices as a structured dashboard data record.

10. The system according to claim 9, wherein the circuitry is configured to update the dashboard data record at a configurable refresh interval by re-applying the generative neural network model to the most recently filtered time-series operational metric data, and transmit push notification data to terminal devices when a predicted metric value crosses a configurable alert threshold.

11. The system according to claim 1, wherein the circuitry is configured to update the machine learning model for resource allocation optimization by generating training pairs from historical resource allocation adjustment vectors and corresponding validated outcome metric records, and fine-tune the model to reduce prediction error on the most recent operational window.

12. The system according to claim 1, wherein the circuitry is configured to generate a cross-node operational summary report by aggregating operational state data records across all monitored computing nodes, apply the generative neural network model to generate a natural language summary of key findings, and transmit the summary report to terminal devices associated with management user identifiers at configurable periodic intervals.

13. The system according to claim 1, wherein the circuitry is configured to enforce a role-based access control policy by verifying a user role parameter associated with the terminal device before permitting access to operational state data records or system control parameter records, and apply data filtering to return only data fields authorized for the requesting user role.

14. The system according to claim 1, wherein the circuitry is configured to store all operational state data records, system control parameter records, and resource configuration command records in an audit log data structure with timestamps and computing node identifiers, and generate a system performance history report from the audit log data structure.

15. The system according to claim 1, wherein the circuitry is configured to receive natural language query data from a terminal device via the communication interface describing a specific operational concern, apply the generative neural network model to retrieve relevant operational state records from the vector database by cosine similarity search, and generate a natural language response addressing the queried operational concern.

16. The system according to claim 1, wherein the circuitry is configured to apply a capacity planning model to the resource demand prediction vector by projecting future resource requirements over a configurable planning horizon, compare the projected resource requirements against current infrastructure capacity parameters, and generate a capacity expansion recommendation data record when projected requirements exceed available capacity.

17. The system according to claim 1, wherein the time-series operational metric data comprises processing unit utilization rates, memory consumption values, and network traffic values from computing nodes in a distributed processing environment, and the resource allocation adjustment vector specifies scaling parameters for virtual machine instances and containerized services.

18. A system comprising:
circuitry configured to:
receive, via a communication interface coupled to a packet-switched network, time-series operational metric data from computing nodes, apply a moving average filter to remove noise, and apply a machine learning model to generate resource allocation adjustment vectors and transmit resource configuration commands;
apply a transformer-based time-series model to generate multi-step ahead resource demand prediction vectors with prediction confidence intervals;
apply an autoencoder anomaly detection model to detect operational anomalies, and apply a generative neural network model to generate operational state data records and system control parameter records from resource demand prediction vectors and historical operational records; and
transmit operational state data records, system control parameter records, and visualization dashboard data to terminal devices via the communication interface.

19. The system according to claim 18, wherein the circuitry is configured to deploy functional units as containerized microservices communicating via publish-subscribe message queues, generate cross-node operational summary reports by aggregating operational state data records, and apply a capacity planning model to resource demand prediction vectors to generate capacity expansion recommendation data records when projected requirements exceed available capacity.

20. A method comprising:
receiving, via a communication interface coupled to a packet-switched network, time-series operational metric data from a plurality of computing nodes, applying a moving average filter to remove noise, and storing the filtered data in a storage device;
applying a machine learning model to compute a resource allocation adjustment vector, and transmitting resource configuration commands to computing node control interfaces based on the resource allocation adjustment vector;
applying a generative neural network model to generate an operational state data record comprising metric deviation indicators, capacity utilization parameters, and a resource demand prediction vector;
generating a system control parameter record comprising parameter adjustment sequences and predicted metric trajectories by applying the generative neural network model to the resource demand prediction vector and historical operational records; and
transmitting the operational state data record and the system control parameter record to terminal devices via the communication interface.
